(19) United States
(12) Patent Application Publication
(10) Pub. No.: US 2026/0188184 A1
(43) Pub. Date: Jul. 2, 2026

(54) PIXEL CIRCUIT

(71) Applicant: AUO Corporation, Hsinchu City (TW)

(72) Inventor: Wei-Li LIN, Hsinchu City (TW)

(21) Appl. No.: 19/240,688

(22) Filed: Jun. 17, 2025

(30) Foreign Application Priority Data
Dec. 27, 2024 (TW) 113151222

(51) Int. Cl. G09G 3/32; G09G 3/20

(52) U.S. Cl. CPC G09G 3/32; G09G 3/2007; G09G 3/2092; G09G 2300/0819; G09G 2300/0842; G09G 2300/0861; G09G 2310/08; G09G 2320/0626

(57) ABSTRACT

A pixel circuit including an LED, a first internal-node setting transistor, a second internal-node setting transistor, and a light-intensity control transistor is provided. The LED is electrically connected to a supply voltage line and the first internal-node setting transistor. The first internal-node setting transistor is electrically connected a first internal-node. The second internal-node setting transistor is electrically connected to a second internal-node and a data-line. The data-line is equivalent to a pixel-data setting voltage during a pixel-data voltage-setting duration. A pixel current flows through the LED, the first internal-node setting transistor, the first internal-node, and the light-intensity control transistor during a pixel light-emission duration. The pixel current is related to the first and the second internal-nodes during the pixel light-emission duration. The voltage of the second internal-node during the pixel light-emission duration is related to a threshold voltage of the light-intensity control transistor and the pixel-data setting voltage.

This application claims the benefit of Taiwan application Serial No. 113151222, filed Dec. 27, 2024, the disclosure of which is incorporated by reference herein in its entirety.

### TECHNICAL FIELD

The disclosure relates in general to a pixel circuit, and more particularly to a pixel circuit capable of reducing the number of control parameters of the light-intensity of micro light emitting diode and improving the aperture ratio of the display panel.

### BACKGROUND

With advantages such as high efficiency and low power, micro light emitting diode (hereinafter, μ LED) display panels have become popular over recent years. FIG. 1 (prior art) is a schematic diagram illustrating a μ LED display panel. The μ LED display panel 10 is electrically connected to a timing control circuit through M data-lines DAT[1]˜DAT[M] and N gate-lines GL[1]˜GL[N]. The timing control circuit may further include a timing controller, a source driver, a row (gate) driver, and so forth. Details about the internal circuits and operations of the timing control circuit are omitted in the description.

During the X frame periods Tframe[1]˜Tframe[X], the timing control circuit controls the voltages of the data-line signals DAT[1]˜DAT[M] and the gate-line signals GL[1]˜GL[N] to determine the image contents to be displayed by the μ LED display panel 10. For the sake of illustrations, the signal lines and the signals they carry are represented with the same symbols in the present disclosure. For example, DAT[m] represents both the data-line and the data-line signal.

The μ LED display panel 10 includes pixel circuits PXL(1, 1)˜PXL(M, N) arranged in M columns and N rows. The pixel circuit PXL(m, n) is electrically connected to the data-line DAT[m] at the m-th column and the gate-line GL[n] at the n-th row. During the x-th frame period Tframe[x], the timing control circuit sequentially controls the gate-lines GL[1]˜GL[N] to generate pulses to enable the pixel circuits PXL(1˜M, 1)˜PXL(1˜M, N) row by row (n=1˜N). The variables m, n, x, M, N, and X are positive integers, wherein m ≤M, n≤N, and x≤X.

Besides, the light-intensities of the pixel circuits PXL(1, 1)˜PXL(M, N) during the x-th frame period Tframe[x] are changed with the voltages of the data-line signals DAT[1]˜DAT[M]. For example, the data-line signal DAT[m]has the lowest voltage (for example, 2V) if the grayscale of the pixel circuit PXL(m, n) during the x-th frame period Tframe[x] is L255. Alternately, the data-line signal DAT[m]has the highest voltage (for example, 10V) if the grayscale of the pixel circuit PXL(m, n) during the x-th frame period Tframe[x] is L0.

FIG. 2 (prior art) is a schematic diagram illustrating a conventional μ LED pixel circuit. The pixel circuit PXLo(m, n) is electrically connected to the supply voltage line Vdd (for example, 10V), the ground voltage line (for example, 0V), the data-line DAT[m], the light-emission activate gate-line EM[n], and the pixel-data setting gate-line WS[n]. The light-emission activate gate-line EM[n] and pixel-data setting gate-line WS[n] are subcategories of the gate-lines GL[n].

The light-intensity of the μ LED(m, n) in the pixel circuit PXL(m, n) is dominated by the current value of the pixel current I_{LED}(m, n) flowing through the μ LED(m, n). In this schematic diagram, the current value of the pixel current I_{LED}(m, n) can be represented by the current formula as in equation 1. In equation 1, the parameter Vgs is the voltage difference between the gate terminal G and the source terminal of the light-intensity control transistorTled(m, n), the parameter K is a constant, and the parameter Vth is the threshold voltage of the light-intensity control transistor Tled(m, n). When the μ LED(m, n) emits light, the voltage difference Vgs between the gate terminal G and the source terminal S of the light-intensity control transistor Tled(m, n) can be further represented as the voltage difference between the voltage of the data-line signal DAT[m] and the supply voltage Vdd. That is, Vgs=(DAT[m]−Vdd).

$${I}_{L E D} ( m , n ) = {K ( V gs - V th )}^{2} = {K ( ( D A T [ m ] - V dd ) - V th )}^{2} \qquad ( equation 1 )$$

As shown in equation 1, the current value of the pixel current I_{LED}(m, n) flowing through the μ LED(m, n) is affected not only by the voltage of the data-line signal DAT[m] but also by the supply voltage Vdd and the threshold voltage Vth of the light-intensity control transistor Tled(m, n). However, as the supply voltage Vdd is provided to M*N pixel circuits PXL(1, 1)˜PXL(M, N) at the same time, the supply voltage Vdd might exhibit fluctuations or instability during operations. Moreover, the threshold voltage Vth of the light-intensity control transistor Tled(m, n) might vary with the manufacturing process of the transistor. Consequentially, more parameters must be considered when the timing control circuit needs to precisely control the light-intensity of the μ LED(m, n) in the pixel circuit PXLo(m, n).

### SUMMARY

A pixel circuit is provided in the present invention. The pixel circuit, according to the present invention, has a higher aperture ratio, and the light-intensity of the LED in the pixel circuit is not affected by the threshold voltage of the light-intensity control transistor.

According to one embodiment, a pixel circuit is provided. The pixel circuit includes a light-emitting diode, a first-first internal-node setting transistor, a first-second internal-node setting transistor, and a light-intensity control transistor. The light-emitting diode has a terminal being electrically connected to a supply voltage line. The first-first internal-node setting transistor is electrically connected to the other terminal of the light-emitting diode and a first internal-node. The first-second internal-node setting transistor is electrically connected to a second internal-node and a data-line, wherein a voltage of the data-line during a pixel-data voltage-setting duration is equivalent to a pixel-data setting voltage. The light-intensity control transistor is electrically connected to the first internal-node, the second internal-node, and a ground voltage line. The voltage of the supply voltage line is greater than the voltage of the ground voltage line. A pixel current flows from the supply voltage line to the ground voltage line, through the light-emitting diode, the first-first internal-node setting transistor, the first internal-node, and the light-intensity control transistor during a pixel light-emission duration after the pixel-data voltage-setting duration ends. The current value of the pixel current is related to the voltage of the first internal-node and the voltage of the second internal-node during the pixel light-emission duration, and the voltage of the second internal-node during the pixel light-emission duration is related to a threshold voltage of the light-intensity control transistor and the pixel-data setting voltage.

According to another embodiment, a pixel circuit is provided. The pixel circuit includes a light-emitting diode, a light-emission activate transistor, a light-intensity control transistor, a first-first internal-node setting transistor, and a second-first internal-node setting transistor. The light-emitting diode has a terminal being electrically connected to a ground voltage line. The light-emission activate transistor is electrically connected to the other terminal of the light-emitting diode. The light-intensity control transistor is electrically connected to the light-emission activate transistor, a first internal-node, and a second internal-node. The first-first internal-node setting transistor is electrically connected to the first internal-node and a supply voltage line. The voltage of the supply voltage line is greater than the voltage of the ground voltage line. The second-first internal-node setting transistor is electrically connected to the first internal-node and a data-line. The voltage of the data-line is equivalent to a pixel-data setting voltage during a pixel-data voltage-setting duration. A pixel current flows from the supply voltage line to the ground voltage line, through the first-first internal-node setting transistor, the first internal-node, the light-intensity control transistor, and the light-emitting diode, during a pixel light-emission duration after the pixel-data voltage-setting duration ends. The current value of the pixel current is related to the voltage of the first internal-node and the voltage of the second internal-node during the pixel light-emission duration, and the voltage of the second internal-node during the pixel light-emission duration is related to a threshold voltage of the light-intensity control transistor and the pixel-data setting voltage.

### BRIEF DESCRIPTION OF THE DRAWINGS

FIG. 1 (prior art) is a schematic diagram illustrating a μLED display panel.

FIG. 2 (prior art) is a schematic diagram illustrating a conventional μLED pixel circuit.

FIG. 3 is a schematic diagram illustrating the embodiment of the pixel circuit PXLa(m, n) according to the concept of the present disclosure.

FIG. 4 is a waveform diagram illustrating how the timing control circuit controls the pixel circuit PXLa(m, n) to emit light in FIG. 3.

FIG. 5A is a schematic diagram illustrating the circuit state of the pixel circuit PXLa(m, n) in FIG. 3 when the pixel circuit PXLa(m, n) operates during the light-intensity reset duration Trs.

FIG. 5B is a schematic diagram illustrating the circuit state of the pixel circuit PXLa(m, n) in FIG. 3 when the pixel circuit PXLa(m, n) operates during the pixel-data voltage-setting duration Tdat_wrt.

FIG. 5C is a schematic diagram illustrating the circuit state of the pixel circuit PXLa(m, n) in FIG. 3 when the pixel circuit PXLa(m, n) operates during the pixel light-emission duration Tem.

FIG. 6A is a schematic diagram illustrating the embodiment of the pixel circuit PXLb1(m, n) according to the concept of the present disclosure.

FIG. 6B is a waveform diagram illustrating how the timing control circuit controls the pixel circuit PXLb1(m, n) in FIG. 6A.

FIG. 7 is a schematic diagram illustrating the embodiment of the pixel circuit PXLb2(m, n) according to the concept of the present disclosure.

FIG. 8 is a schematic diagram illustrating the embodiment of the pixel circuit PXLb3(m, n) according to the concept of the present disclosure.

FIG. 9 is a schematic diagram illustrating the embodiment of the pixel circuit PXLc(m, n) according to the concept of the present disclosure.

FIGS. 10A and 10B are waveform diagrams corresponding to the scenarios assuming that the source terminal S of the control-combined transistor Tmctl in FIG. 9 is electrically connected to the ground voltage line Vss and the preset voltage line Vini, respectively.

FIG. 11 is a schematic diagram illustrating the embodiment of the pixel circuit PXLd1(m, n) according to the concept of the present disclosure.

FIG. 12 is a waveform diagram corresponding to the embodiment of the pixel circuit PXLd1(m, n) in FIG. 11.

FIG. 13A is a schematic diagram illustrating the circuit state of the pixel circuit PXLd1(m, n) in FIG. 11 when the pixel circuit PXLd1(m, n) operates during the light-intensity reset duration Trs.

FIG. 13B is a schematic diagram illustrating the circuit state of the pixel circuit PXLd1(m, n) in FIG. 11 when the pixel circuit PXLd1(m, n) operates during the pixel-data voltage-setting duration Tdat_wrt.

FIG. 13C is a schematic diagram illustrating the circuit state of the pixel circuit PXLd1(m, n) in FIG. 11 when the pixel circuit PXLd1(m, n) operates during the pixel light-emission duration Tem.

FIG. 14 is a schematic diagram illustrating the embodiment of the pixel circuit PXLd2(m, n) according to the concept of the present disclosure.

FIG. 15 is a waveform diagram corresponding to the pixel circuit PXLd2(m, n) in FIG. 14.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

To facilitate the timing control circuit to control the light-intensity of the pixel circuit PXL(m, n), the present disclosure provides several embodiments showing different designs of pixel circuit PXL(m, n). In the following embodiments, the number of the parameters related to the pixel current I_{LED}(m, n) flowing through the μ LED(m, n) is fewer than that in the conventional pixel circuit PXLo(m, n), and the complexities regarding how the timing control circuit controls the pixel circuit PXL(m, n) can be reduced.

There are several control approaches that the timing control circuit utilizes the data-line signal DAT[m] to transmit the pixel-data setting voltage Vdata(m, n) to the pixel circuit PXL(m, n). For example, the pixel-data setting voltage Vdata(m, n) can be controlled by a pulse width modulation (hereinafter, PWM) approach, by a pulse amplitude modulation (hereinafter, PAM) approach, or by a partial PWM and partial PAM approach. Below, the present disclosure provides the embodiments based on two types of PAM approaches that the timing control circuit adopts to control the pixel-data setting voltage Vdata(m, n) of the pixel circuit PXL(m, n).

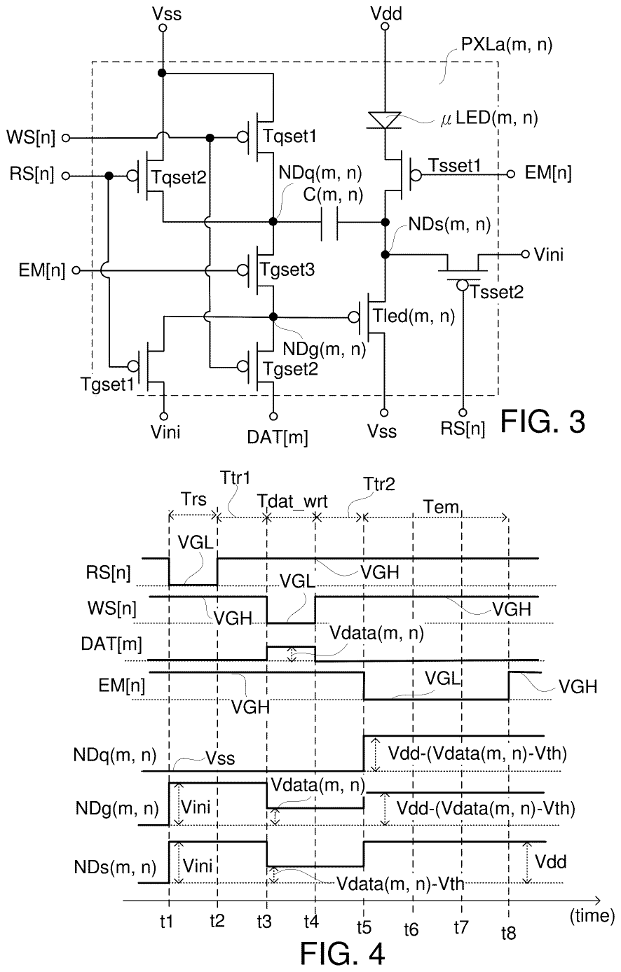

First, the pixel circuit controlled by the PAM approach according to the first type of embodiment of the present disclosure is illustrated. FIG. 3 is a schematic diagram illustrating the embodiment of the pixel circuit PXLa(m, n) according to the concept of the present disclosure. The pixel circuit PXLa(m, n) is electrically connected to the ground voltage line Vss, the supply voltage line Vdd, the preset voltage line Vini, the pixel-data setting gate-line WS[n], the reset gate-line RS[n], the light-emission activate gate-line EM[n], and the data-line DAT[m]. The supply voltage line Vdd provides the supply voltage (for example, 10V), and the ground voltage line Vss provides the ground voltage (for example, 0V).

When the supply voltage Vdd is provided to M*N pixel circuits at the same time, the voltage value of the supply voltage Vdd might not be stable, and an unexpected voltage drop may occur. According to the first type of embodiment, an additional and independent preset voltage Vini having a voltage value (for example, 10V) equivalent to the supply voltage can be placed to avoid the unexpected voltage drop of the supply voltage Vdd. The voltages of the pixel-data setting gate-line signal WS[n], the reset gate-line signal RS[n], and the light-emission activate gate-line signal EM[n] are between the low gate-control voltage VGL (for example, −5V) and the high gate-control voltage VGH (for example, 15V).

The pixel circuit PXLa(m, n) includes a capacitor C(m, n), a μ LED(m, n), internal-node setting transistors Tgset1, Tgset2, Tgset3, Tqset1, Tqset2, Tsset2, and Tsset1, and a light-intensity control transistor Tled(m, n). The internal-node setting transistors Tgset1, Tgset2, and Tgset3 are transistors utilized to set the voltage of the internal-node NDg(m, n), the internal-node setting transistors Tqset1 and Tqset2 are transistors utilized to set the voltage of the internal-node NDq(m, n), and the internal-node setting transistors Tsset1 and Tsset2 transistors are utilized to set the voltage of the internal-node NDs(m, n). The connections between these components are illustrated below.

The two terminals of the capacitor C(m, n) are respectively electrically connected to the internal-nodes NDq(m, n) and NDs(m, n). The anode of the μ LED(m, n) is electrically connected to the supply voltage line Vdd, and the cathode of the μ LED(m, n) is electrically connected to the source terminal S of the internal-node setting transistor Tsset1.

The source terminal S of the internal-node setting transistor Tgset2 is electrically connected to the internal-node NDg(m, n), the gate terminal G of the internal-node setting transistor Tgset2 is electrically connected to the pixel-data setting gate-line WS[n], and the drain terminal D of the internal-node setting transistor Tgset2 is electrically connected to the data-line DAT[n]. The source terminal S of the internal-node setting transistor Tgset1 is electrically connected to the internal-node NDg(m, n), the gate terminal G of the internal-node setting transistor Tgset1 is electrically connected to the reset gate-line RS[n], and the drain terminal D of the internal-node setting transistor Tgset1 is electrically connected to the preset voltage line Vini. The source terminal S of the light-intensity control transistor Tled(m, n) is electrically connected to the internal-node NDs(m, n), the gate terminal G of the light-intensity control transistor Tled(m, n) is electrically connected to the internal-node NDg(m, n), and the drain terminal D of the light-intensity control transistor Tled(m, n) is electrically connected to the ground voltage line Vss. The source terminal S of the internal-node setting transistor Tqset1 is electrically connected to the ground voltage line Vss, the gate terminal G of the internal-node setting transistor Tqset1 is electrically connected to the pixel-data setting gate-line WS[n], and the drain terminal D of the internal-node setting transistor Tqset1 is electrically connected to the internal-node NDq(m, n). The source terminal S of the internal-node setting transistor Tqset2 is electrically connected to the ground voltage line Vss, the gate terminal G of the internal-node setting transistor Tqset2 is electrically connected to the reset gate-line RS[n], and the drain terminal D of the internal-node setting transistor Tqset2 is electrically connected to the internal-node NDq(m, n). The source terminal S of the internal-node setting transistor Tgset3 is electrically connected to the internal-node NDq(m, n), the gate terminal G of the internal-node setting transistor Tgset3 is electrically connected to the light-emission activate gate-line EM[n], and the drain terminal D of the internal-node setting transistor Tqset3 is electrically connected to the internal-node NDg(m, n). The source terminal S of the internal-node setting transistor Tsset2 is electrically connected to the preset voltage line Vini, the gate terminal G of the internal-node setting transistor Tsset2 is electrically connected to the reset gate-line RS[n], and the drain terminal D of the internal-node setting transistor Tsset2 is electrically connected to the internal-node NDs(m, n). The source terminal S of the internal-node setting transistor Tsset1 is electrically connected to the catelectrode of the μ LED(m, n), the gate terminal G of the internal-node setting transistor Tsset1 is electrically connected to the light-emission activate gate-line EM[n], and the drain terminal D of the internal-node setting transistor Tsset1 is electrically connected to the internal-node NDs(m, n).

FIG. 4 is a waveform diagram illustrating how the timing control circuit controls the pixel circuit PXLa(m, n) to emit light in FIG. 3. The horizontal axis represents time in this diagram. From top to bottom, the vertical axis represents the voltages of the signals received from the timing control circuit, including the reset gate-line signal RS[n], the pixel-data setting gate-line signal WS[n], the data-line signal DAT[m], and the light-emission activate gate-line signal EM[n], and the voltages of the internal-nodes NDq(m, n), NDg(m, n), and NDs(m, n) in the pixel circuit PXLa(m, n). The timing control circuit controls the pixel circuit PXLa(m, n) to emit light between the time point t1 and the time point t8. The time durations between successive points are equal in duration. In the following, how the signals, including the reset gate-line signal RS[n], the pixel-data setting gate-line signal WS[n], the data-line signal DAT[m], and the light-emission activate gate-line signal EM[n], that the pixel circuit PXLa(m, n) receives from the timing control circuit change in the duration between the time point t1 and the time point t8 is illustrated.

The voltage of the reset gate-line signal RS[n]drops from the high gate-control voltage VGH to the low gate-control voltage VGL (RS[n]=VGH→VGL) at the time point t1 and rises from the low gate-control voltage VGL to the high gate-control voltage VGH (RS[n]=VGL→VGH) at the time point t2. Moreover, the voltage of the reset gate-line signal RS[n]maintains at the high gate-control voltage VGH (RS[n]=VGH) after the time point t2. In the present disclosure, the duration when the voltage of the reset gate-line signal RS[n] is equivalent to the low gate-control voltage VGL (RS[n]=VGL) is defined as the light-intensity reset duration Trs.

The voltage of the pixel-data setting gate-line signal WS[n]remains at the high gate-control voltage VGH (WS[n]=VGH) before the time point t3. The voltage of the pixel-data setting gate-line signal WS[n] is equivalent to the low gate-control voltage VGL (WS[n]=VGL) between the time point t3 and the time point t4, and changes again from the low gate-control voltage VGL to the high gate-control voltage VGH (WS[n]=VGL→VGH) at the time point t4. The voltage of the pixel-data setting gate-line signal WS[n]remains at the high gate-control voltage VGH (WS[n]=VGH) after the time point t4. In the present disclosure, the duration when the voltage of the pixel-data setting gate-line signal WS[n] is equivalent to the low gate-control voltage VGL (WS[n]=VGL), that is, the duration between the time point t3 and the time point t4, is defined as the pixel-data voltage-setting duration Tdat_wrt.

For the sake of illustration, it is assumed that the voltage of the data-line signal DAT[m] is equivalent to the ground voltage Vss (DAT[m]=Vss) before the time point t3 and after the time point t4. The pixel-data setting voltage Vdata(m, n) during the duration between the time point t3 and the time point t4 is determined by the grayscale (L0˜L255) that the timing control circuit sets for the pixel circuit PXLa(m, n). For example, the pixel-data setting voltage Vdata(m, n) at the data-line DAT[m]during the pixel-data voltage-setting duration Tdat_wrt is set to be equivalent to 6V (DAT[m]=6V) if the pixel circuit PXLa(m, n) corresponds to the grayscale L0, and the pixel-data setting voltage Vdata(m, n) at the data-line DAT[m]during the pixel-data voltage-setting duration Tdat_wrt is set to be equivalent to 2V (DAT[m]=2V) if the pixel circuit PXLa(m, n) corresponds to the grayscale L255.

The voltage of the light-emission activate gate-line signal EM[n]remains at the high gate-control voltage VGH (EM[n]=VGH) before the time point t5. At the time point t5, the voltage of the light-emission activate gate-line signal EM[n]changes from the high gate-control voltage VGH to the low gate-control voltage VGL (EM[n]=VGH+VGL). Then, the voltage of the light-emission activate gate-line signal EM[n]remains at the low gate-control voltage VGL (EM[n]=VGL) between the time point t5 and the time point t8, and changes again from the low gate-control voltage VGL to the high gate-control voltage VGH (EM[n]=VGL→VGH) at time point t8. In the present disclosure, the duration when the voltage of the light-emission activate gate-line signal EM[n] is equivalent to the low gate-control voltage VGL (EM[n]=VGL) is defined as the pixel light-emission duration Tem.

In the present disclosure, the duration when the voltage of the reset gate-line signal RS[n] is equivalent to the low gate-control voltage VGL (RS[n]=VGL) is defined as the light-intensity reset duration Trs, the duration when the voltage of the pixel-data setting gate-line signal WS[n] is equivalent to the low gate-control voltage VGL (WS[n]=VGL) is defined as the pixel-data voltage-setting duration Tdat_wrt, and the duration when the voltage of the light-emission activate gate-line signal EM[n] is equivalent to the low gate-control voltage VGL (EM[n]=VGL) is defined as the pixel light-emission duration Tem.

To simplify the timing sequence of the signal switch control, the voltage of the pixel-data setting gate-line signal WS[n]does not immediately change from the high gate-control voltage VGH to low gate-control voltage VGL (WS[n]=VGH+VGL) when the reset gate-line signal RS[n]switches from the low gate-control voltage VGL to the high gate-control voltage VGH (RS[n]=VGL→VGH) at the time point t2. Instead, the pixel-data setting gate-line signal WS[n]waits for the transition duration Ttr1 before proceeding with its voltage transition (WS[n]=VGH+VGL). Similarly, the voltage of the light-emission activate gate-line signal EM[n]does not immediately change from the high gate-control voltage VGH to the low gate-control voltage VGL (EM[n]=VGH+VGL) when the voltage of the pixel-data setting gate-line signal WS[n]switches from the low gate-control voltage VGL to the high gate-control voltage VGH (WS[n]=VGL→VGH) at the time point t4. Instead, the light-emission activate gate-line EM[n]waits for the transition duration Ttr2 before proceeding with its voltage transition (EM[n]=VGH→VGL).

Alternatively speaking, the waveforms of the reset gate-line signal RS[n], the pixel-data setting gate-line signal WS[n], the data-line signal DAT[m], and the light-emission activate gate-line signal EM[n]during the transition durations Ttr1 and Ttr2 are determined based on buffering control purpose. Thus, only the circuit behavior of the pixel circuit PXL(m, n) during the light-intensity reset duration Trs, the pixel-data voltage-setting duration Tdat_wrt, and the pixel light-emission duration Tem are illustrated below.

Furthermore, as the data-line DAT[m] is electrically connected to the N pixel circuits PXLa(m, 1)˜PXLa(m, N) located at the m-th column at the same time, and the timing control circuit alternately enables the N pixel circuits PXLa(m, 1)˜PXLa(m, N) located at the m-th column row by row (n=1˜N), the timing control circuit can set the voltage of the data-line signal DAT[m] to be equivalent to the pixel-data setting voltage Vdata(m, n+1) corresponding to the pixel circuit PXLa(m, n+1) located at the m-th column and the (n+1)-th row before starting control the pixel circuit PXLa(m, n+1). That is, the pixel-data setting voltage Vdata(m, n+1) for setting the grayscale of the pixel circuit PXLa(m, n+1) located at the same column (that is, the m-th column) but next row (that is, the (n+1)-th row) of the pixel circuit PXLa(m, n) is prepared in advance (starting from the time point t4). Similarly, the timing controller may set the voltage of the data-line signal DAT[m] to be equivalent to the pixel-data setting voltage Vdata(m, n) corresponding to the grayscale of the pixel-data setting voltage Vdata(m, n) of the pixel circuit PXLa(m, n) before the time point t3, for example, immediately after the pixel-data voltage-setting duration Tdat_wrt corresponding to the pixel circuit PXLa(m, n−1) located at the m-th column and the (n−1)-th row ends. The disclosure does not illustrate these variations in practical applications.

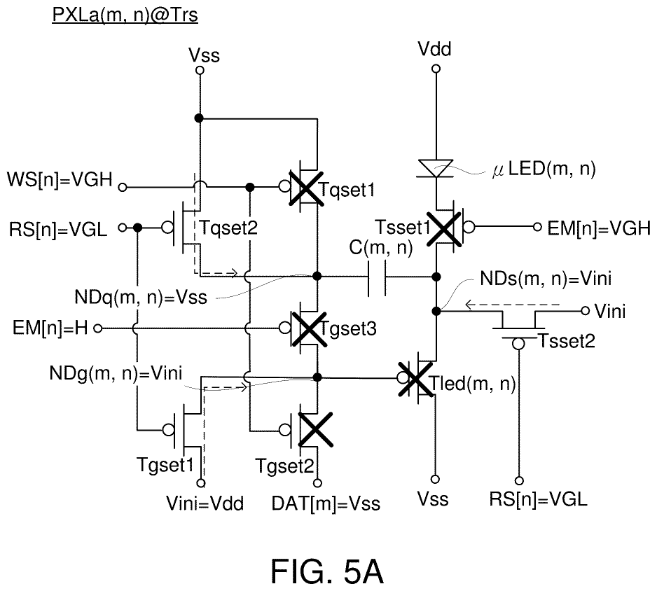

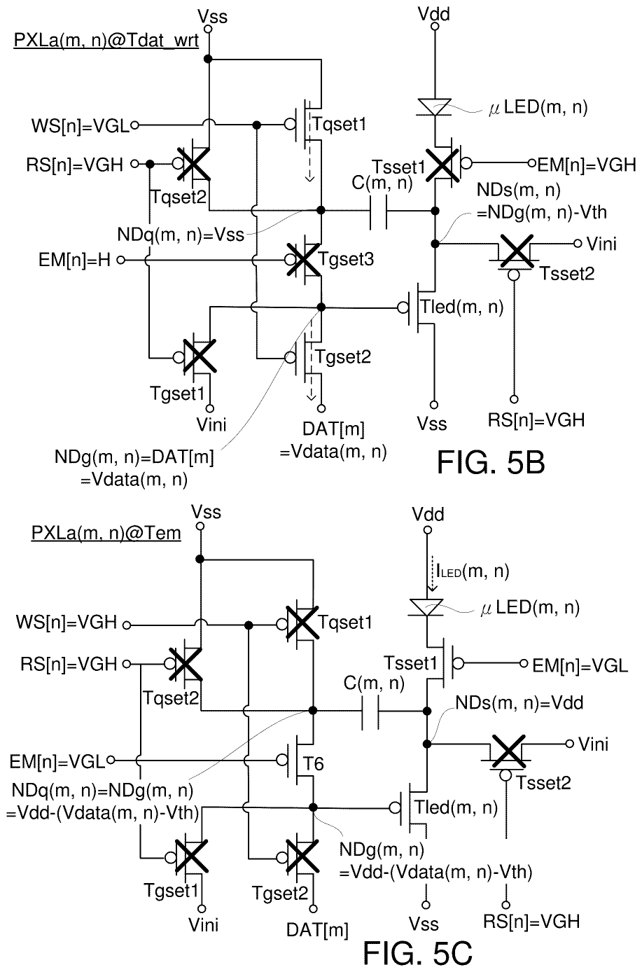

Please refer to FIGS. 4 and 5A-5C for illustrations about how the voltages of the internal-nodes NDq(m, n), NDg(m, n), and NDs(m, n) in the pixel circuit PXLa(m, n) change with the voltages of the reset gate-line signal RS[n], the pixel-data setting gate-line signal WS[n], the data-line signal DAT[m], and the light-emission activate gate-line signal EM[n]during the light-intensity reset duration Trs, the pixel-data voltage-setting duration Tdat_wrt, and the pixel light-emission duration Tem. In the present disclosure, the dashed arrows represent the voltage-conducting direction, and the X marks represent transistors at the OFF state.

FIG. 5A is a schematic diagram illustrating the circuit state of the pixel circuit PXLa(m, n) in FIG. 3 when the pixel circuit PXLa(m, n) operates during the light-intensity reset duration Trs. Please refer to FIGS. 3, 4 and 5A together. During the light-intensity reset duration Trs (that is, the duration between the time point t1 and the time point t2 in FIG. 4), the voltage of the reset gate-line signal RS[n] is equivalent to the low gate-control voltage VGL (RS[n]=VGL), the voltage of the pixel-data setting gate-line signal WS[n] is equivalent to the high gate-control voltage VGH (WS[n]=VGH), the voltage of the data-line signal DAT[m] is equivalent to the ground voltage Vss (DAT[m]=Vss), and the voltage of the light-emission activate gate-line signal EM[n] is equivalent to the high gate-control voltage VGH (EM[n]=VGH). Consequentially, the internal-node setting transistors Tgset1, Tqset2, and Tsset2 are switched on in response to the low gate-control voltage VGL at the reset gate-line RS[n](RS[n]=VGL), the internal-node setting transistors Tgset2 and Tqset1 are switched off in response to the high gate-control voltage VGH at the pixel-data setting gate-line WS[n](WS[n]=VGH), and the internal-node setting transistors Tgset3 and Tsset1 are switched off in response to the high gate-control voltage VGH at the light-emission activate gate-line EM[n](EM[n]=VGH). Based on the ON/OFF states of the internal-node setting transistors Tgset2, Tgset1, Tqset1, Tqset2, Tgset3, Tsset2, and Tsset1, how the transistors related to the internal-nodes NDq(m, n), NDg(m, n), and NDs(m, n) affect the voltages of the internal-nodes NDq(m, n), NDg(m, n), and NDs(m, n) during the light-intensity reset duration Trs, and how the voltages of the internal-nodes NDg(m, n) and NDs(m, n) affect the ON/OFF state of the light-intensity control transistor Tled(m, n) are illustrated sequentially.

During the light-intensity reset duration Trs, the internal-node setting transistor Tqset2 at the ON-state conducts the ground voltage Vss to the internal-node NDq(m, n), and the internal-node setting transistor Tqset1 at the OFF state does not affect the voltage of the internal-node NDq(m, n). Thus, the voltage of the internal-node NDq(m, n) is equivalent to the ground voltage Vss (NDq(m, n)=Vss) during the light-intensity reset duration Trs. Besides, during the light-intensity reset duration Trs, the voltage of the internal-node NDg(m, n) is not affected by the internal-node setting transistors Tgset2 Tgset3 at the OFF state, and the internal-node setting transistor Tgset1 at the ON state conducts the preset voltage Vini to the internal-node NDg(m, n). Thus, the voltage of the internal-node NDg(m, n) is equivalent to the preset voltage Vini (NDg(m, n)=Vini) during the light-intensity reset duration Trs.

Besides, the voltage of the internal-node NDs(m, n) is not affected by the internal-node setting transistor Tsset1 at the OFF state during the light-intensity reset duration Trs. Meanwhile, the internal-node setting transistor Tsset2 at ON-state conducts the preset voltage Vini to the internal-node NDs(m, n). Thus, the voltage of the internal-node NDs(m, n) is equivalent to the preset voltage Vini (NDs(m, n)=Vini) during the light-intensity reset duration Trs.

The source terminal S of the light-intensity control transistor Tled(m, n) is electrically connected to the internal-node NDs(m, n), and the gate terminal G of the light-intensity control transistor Tled(m, n) is electrically connected to the internal-node NDg(m, n). Based on the illustrations above, the voltage of the internal-node NDs(m, n) is equivalent to the preset voltage Vini (NDs(m, n)=Vini), and the voltage of the internal-node NDg(m, n) is equivalent to the preset voltage Vini (NDg(m, n)=Vini) during the light-intensity reset duration Trs. Consequentially, the light-intensity control transistor Tled(m, n) is switched off because the voltage difference Vgs between the gate terminal G and the source terminal S of the light-intensity control transistor Tled(m, n) is equivalent to OV (Vgs=0V). Meanwhile, no pixel current I_{LED}(m, n) flows through the μ LED(m, n), and the μ LED(m, n) does not emit light during the light-intensity reset duration Trs.

FIG. 5B is a schematic diagram illustrating the circuit state of the pixel circuit PXLa(m, n) in FIG. 3 when the pixel circuit PXLa(m, n) operates during the pixel-data voltage-setting duration Tdat_wrt. Please refer to FIGS. 3, 4, and 5B together. During the pixel-data voltage-setting duration Tdat_wrt (the duration between the time point t3 and time point t4 in FIG. 4), the voltage of the reset gate-line signal RS[n] is equivalent to the high gate-control voltage VGH (RS[n]=VGH), the voltage of the pixel-data setting gate-line signal WS[n] is equivalent to the low gate-control voltage VGL (WS[n]=VGL), the voltage of the data-line signal DAT[m] is equivalent to the pixel-data setting voltage Vdata(m, n) (DAT[m]=Vdata(m, n)), and the voltage of the light-emission activate gate-line signal EM[n] is equivalent to the high gate-control voltage VGH (EM[n]=VGH).

Consequentially, the internal-node setting transistors Tgset1, Tqset2, and Tsset2 are switched off in response to the high gate-control voltage VGH at the reset gate-line RS[n](RS[n]=VGH), the internal-node setting transistors Tgset2 and Tqset1 are switched on in response to the low gate-control voltage VGL at the pixel-data setting gate-line WS[n](WS[n]=VGL), and the internal-node setting transistors Tgset3 and Tsset1 are switched off in response to the high gate-control voltage VGH at the light-emission activate gate-line EM[n](EM[n]=VGH). Based on the ON/OFF states of the internal-node setting transistors Tgset2, Tgset1, Tqset1, Tqset2, Tgset3, Tsset2, and Tsset1 during the pixel-data voltage-setting duration Tdat_wrt, how the voltages of the internal-nodes NDq(m, n), NDg(m, n), and NDs(m, n) are affected accordingly, and how the voltages of the internal-nodes NDg(m, n) and NDs(m, n) further affect the ON/OFF state of the light-intensity control transistor Tled(m, n) are illustrated.

During the pixel-data voltage-setting duration Tdat_wrt, the internal-node setting transistor Tqset1 at the ON state conducts the ground voltage Vss to the internal-node NDq(m, n). Meanwhile, the internal-node setting transistor Tqset2 at the OFF state does not affect the voltage of the internal-node NDq(m, n). Thus, during the pixel-data voltage-setting duration Tdat_wrt the voltage of the internal-node NDq(m, n) is equivalent to the ground voltage Vss (NDq(m, n)=Vss). Besides, during the pixel-data voltage-setting duration Tdat_wrt, the voltage of the internal-node NDg(m, n) is not affected by the internal-node setting transistors Tgset1 and Tgset3 at the OFF state, and the internal-node setting transistor Tgset2 at the ON state conducts the pixel-data setting voltage Vdata(m, n) at the data-line DAT[m] to the internal-node NDg(m, n). Thus, the voltage of the internal-node NDg(m, n) is equivalent to the pixel-data setting voltage Vdata(m, n) at the data-line DAT[m]during the pixel-data voltage-setting duration Tdat_wrt. That is, NDg(m, n)=DAT[m]=Vdata(m, n).

Moreover, the internal-node setting transistors Tsset2 and Tsset1 at the OFF state do not affect the voltage of the internal-node NDs(m, n) during the pixel-data voltage-setting duration Tdat_wrt. Therefore, the voltage of the internal-node NDs(m, n) is equivalent to the difference between the voltage of the internal-node NDg(m, n) and the threshold voltage Vth of the light-intensity control transistor Tled(m, n) during the pixel-data voltage-setting duration Tdat_wrt. That is, NDs(m, n)=NDg(m, n)−Vth=Vdata(m, n)−Vth. Please note that the threshold voltage Vth has a negative voltage value (for example, −1.5V). As the internal-node setting transistor Tsset1 is switched off in response to the high gate-control voltage VGH at the light-emission activate gate-line EM[n](EM[n]=VGH) during the pixel-data voltage-setting duration Tdat_wrt, no pixel current I_{LED}(m, n) flows through the μ LED(m, n) in FIG. 5B, although the light-intensity control transistor Tled(m, n) is switched on.

FIG. 5C is a schematic diagram illustrating the circuit state of the pixel circuit PXLa(m, n) in FIG. 3 when the pixel circuit PXLa(m, n) operates during the pixel light-emission duration Tem. Please refer to FIGS. 3, 4 and 5C together. During the pixel light-emission duration Tem (that is, the duration between time point t5 and time point t8 in FIG. 4), the voltage of the reset gate-line signal RS[n] is equivalent to the high gate-control voltage VGH (RS[n]=VGH), the voltage of the pixel-data setting gate-line signal WS[n] is equivalent to the high gate-control voltage VGH (WS[n]=VGH), the voltage of the data-line signal DAT[n] is equivalent to the ground voltage Vss (DAT[m]=Vss), and the voltage of the light-emission activate gate-line signal EM[n] is equivalent to the low gate-control voltage VGL (EM[n]=VGL). Consequentially, the internal-node setting transistors Tgset1, Tqset2, and Tsset2 are switched off in response to the high gate-control voltage VGH at the reset gate-line RS[n](RS[n]=VGH), the internal-node setting transistors Tgset2 and Tqset1 are switched off in response to the high gate-control voltage VGH at the pixel-data setting gate-line WS[n](WS[n]=VGH), and the internal-node setting transistors Tgset3 and Tsset1 are switched on in response to the low gate-control voltage VGL at the light-emission activate gate-line EM[n](EM[n]=VGL). Based on the ON/OFF states of the internal-node setting transistors Tgset2, Tgset1, Tqset1, Tqset2, Tgset3, Tsset2, and Tsset1 during the pixel light-emission duration Tem, how the voltages of the internal-nodes NDq(m, n), NDg(m, n), and NDs(m, n) are affected accordingly, and how the voltages of the internal-nodes NDg(m, n) and NDs(m, n) further affect the ON/OFF state of the light-intensity control transistor Tled(m, n) are illustrated.

During the pixel light-emission duration Tem, the voltage of the internal-node NDq(m, n) is not affected by the internal-node setting transistors Tqset1 and Tqset2 at the OFF state. At this stage, the voltage of the internal-node NDq(m, n) is equivalent to the voltage of the internal-node NDg(m, n) because the internal-node setting transistor Tgset3 is switched on. That is, NDq(m, n)=NDg(m, n)=Vdd-(Vdata(m, n)-Vth). During the pixel light-emission duration Tem, the internal-node setting transistors Tsset2 and Tgset1 at the OFF state do not affect the voltage of the internal-node NDg(m, n). Besides, during the pixel light-emission duration Tem, the voltage of the internal-node NDs(m, n) is not affected by the internal-node setting transistor Tsset2 at the OFF state, and the internal-node setting transistor Tsset1 at the ON state conducts the supply voltage Vdd to the internal-node NDs(m, n). That is, NDs(m, n)=Vdd.

According to the illustrations above, the voltage difference Vgs between the gate terminal G and the source terminal S of the light-intensity control transistor Tled(m, n) is equivalent to the voltage difference between the voltage of the internal-node NDg(m, n) and the voltage of the internal-node NDs(m, n). That is, Vgs=NDg(m, n)−NDs(m, n)=[Vdd−(Vdata(m, n)−Vth)]−Vdd=−Vdata(m, n)+Vth. At this stage, the current value of the pixel current I_{LED}(m, n) flowing through the μ LED(m, n) can be represented by equation 2.

$$\begin{matrix}{I}_{L E D} ( m , n ) = {K ( V gs - V th )}^{2} \\ = {K [ ( N D g ( m , n ) - NDs ( m , n ) ) - V th ]}^{2} \\ = K {\{ [ [ V dd - ( V data ( m , n ) - V th ) ] - V dd ] - V th \}}^{2} \\ {= K \{ [ - V data ( m , n ) + V th ] - V th ]}^{2} \\ = {K V ( - V data ( m , n ) )}^{2}\end{matrix} \qquad ( equation 2 )$$

As shown in equation 2, the current value of the pixel current I_{LED}(m, n) flowing through the μ LED(m, n) is related to the pixel-data setting voltage Vdata(m, n) only, and the current value of the pixel current I_{LED}(m, n) is irrelevant to the supply voltage Vdd and the threshold voltage Vth. Thus, the pixel-data setting voltage Vdata(m, n) is the only parameter that the timing control circuit needs to be concerned with while controlling the light-intensity of the pixel circuit PXLa(m, n). Compared with the conventional approaches, how the timing control circuit controls the light-intensity (brightness) of the pixel circuit PXLa(m, n) is relatively simple.

The voltages of the signals shown in FIG. 4 during the light-intensity reset duration Trs, the pixel-data voltage-setting duration Tdat_wrt, and the pixel light-emission duration Tem are summarized in Table 1. Please refer to Table 1 and FIGS. 4 and 5A-5C together.

TABLE 1

| pixel circuitPXLa(m, n) | | duration | | |
|---|---|---|---|---|
| signal | | light- | pixel-data | pixel light- |
| | | intensity | voltage- | emission |
| | | reset | setting | duration |
| | | duration | duration | Tem |
| | | Trs | Tdat_wrt | |
| signal | reset gate- | VGL | VGH | |
| received | line signal | | | |
| from the | RS[n] | | | |
| timing | pixel-data | VGH | VGL | VGH |
| control | setting gate- | | | |
| circuit | line | | | |
| | signal | | | |
| | signalWS[n] | | | |
| | data-line | Vss | Vdata(m, n) | Vss |
| | signal | | | |
| | signalDAT[m] | | | |
| | light-emission | VGH | | VGL |
| | activate gate- | | | |
| | line | | | |
| | signal | | | |
| | signalEM[n] | | | |
| internal- | NDq(m, n) | Vss | | Vdd- |
| node | | | | (Vdata(m, n)-Vth) |
| | Dg(m, n) | Vini | Vdata(m, n) | Vdd-(Vdata(m, |
| | | | | n)-Vth) |
| | NDs(m, n) | Vini | (Vdata(m, | Vdd |
| | | | n)-Vth) | |

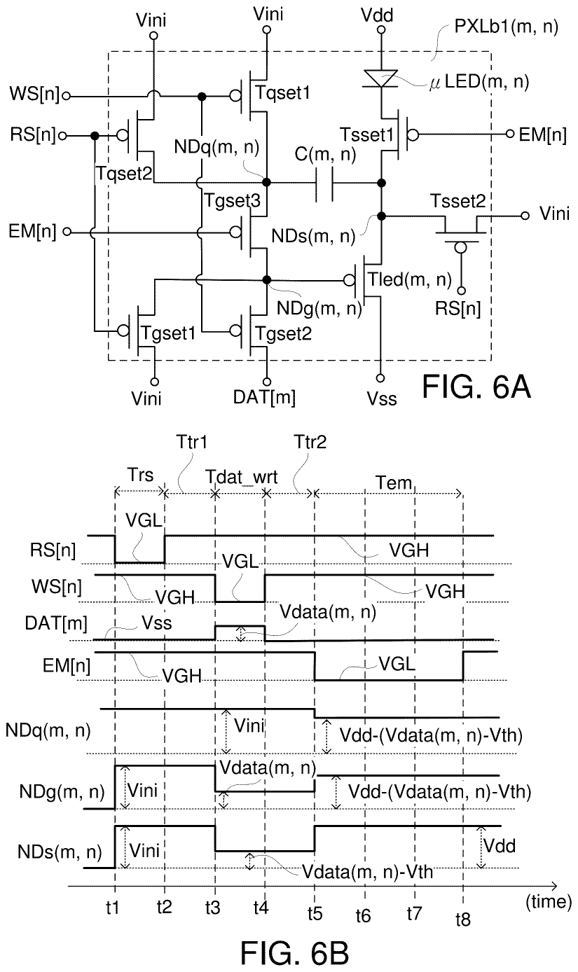

FIG. 6A is a schematic diagram illustrating the embodiment of the pixel circuit PXLb1(m, n) according to the concept of the present disclosure. Please refer to FIGS. 3 and 6A together. The connections of the internal-node setting transistors Tgset2, Tgset1, Tqset1, Tqset2, and Tgset3 and the light-intensity control transistor Tled(m, n) in the pixel circuit in FIG. 3 are roughly similar to those in FIG. 6A. The difference between FIGS. 3 and 6A are how the source terminals S of the internal-node setting transistors Tqset1 and Tqset2 utilized for setting the voltage of the internal-node NDq(m, n) are connected. In FIG. 3, the source terminals S of the internal-node setting transistors Tqset1 and Tqset2 in the pixel circuit PXLa(m, n) are electrically connected to the ground voltage line Vss. On the other hand, the source terminals S of the internal-node setting transistors Tqset1 and Tqset2 in the pixel circuit PXLb1(m, n) in FIG. 6A are electrically connected to the preset voltage line Vini instead.

FIG. 6B is a waveform diagram illustrating how the timing control circuit controls the pixel circuit PXLb1(m, n) in FIG. 6A. As the waveforms in FIG. 6B are similar to FIG. 4, related illustrations are omitted. Please refer to FIGS. 3, 4, 6A, and 6B together.

According to the concept of the present disclosure, the waveforms of the reset gate-line signal RS[n], the pixel-data setting gate-line signal WS[n], the data-line signal DAT[m], and the light-emission activate gate-line signal EM[n]transmitted from the timing control circuit to the pixel circuit PXLb1(m, n) in FIG. 6A are similar to those transmitted to the pixel circuit PXLa(m, n) in FIG. 3. Thus, the waveforms of the reset gate-line signal RS[n], the pixel-data setting gate-line signal WS[n], the data-line signal DAT[n], and the light-emission activate gate-line signal EM[n] in FIG. 6B are identical to those in FIG. 4, and the detailed illustrations are omitted.

Compared with FIG. 3, the source terminals S of the internal-node setting transistors qset1 and Tqset2 in FIG. 6A are reconfigured to connect to the preset voltage line Vini. Therefore, unlike that the voltage of the internal-node NDq(m, n) during the light-intensity reset duration Trs and the pixel-data voltage-setting duration Tdat_wrt is equivalent to the ground voltage Vss (NDq(m, n)=Vss) in FIG. 4, the voltage of the internal-node NDq(m, n) during the light-intensity reset duration Trs and the pixel-data voltage-setting duration Tdat_wrt is equivalent to the preset voltage Vini (NDq(m, n)=Vini) in FIG. 6B. The voltage of the internal-node NDq(m, n) during the pixel light-emission duration Tem is equivalent to Vdd-(Vdata(m, n)-Vth) in FIG. 6A, the same as the voltage of the internal-node NDq(m, n) during the pixel light-emission duration Tem in FIG. 4. Moreover, the voltages of the internal-nodes NDg(m, n) and NDs(m, n) during the light-intensity reset duration Trs, the pixel-data voltage-setting duration Tdat_wrt, and the pixel light-emission duration Tem in FIG. 6B are identical to those in FIG. 4.

Unlike the ones illustrated in FIG. 3 that the source terminals S of the internal-node setting transistors Tqset1 and Tqset2 are electrically connected to the ground voltage Vss, the source terminals S of the internal-node setting transistors Tqset1 and Tqset2 in FIG. 6 are electrically connected to the preset voltage Vini. Despite this, the current value of the pixel current I_{LED}(m, n) can remain unchanged in FIG. 6 as the voltage of the internal-node NDq(m, n) during the light-intensity reset duration Trs and the pixel-data voltage-setting duration Tdat_wrt does not affect the voltage difference Vgs between the gate terminal G and the source terminal S of the light-intensity control transistor Tled(m, n) according to the above illustrations. Therefore, the current formula in equation 2 can be applied to the pixel circuit PXLb1(m, n) in FIG. 6A as well.

The voltages of the internal-nodes NDq(m, n), NDg(m, n), and NDs(m, n) during the light-intensity reset duration Trs, the pixel-data voltage-setting duration Tdat_wrt, and the pixel light-emission duration Tem in FIG. 6B are summarized in Table 2. As the waveforms of the signals received from the timing control circuit, including the reset gate-line signal RS[n], the pixel-data setting gate-line signal WS[n], the data-line signal DAT[n], and the light-emission activate gate-line signal EM[n], are identical in FIGS. 3 and 6A, these signals are not repetitively listed in Table 2. Please refer to Table 2 and FIGS. 6A and 6B together.

TABLE 2

| pixel circuit | | | | |
|---|---|---|---|---|
| PXLb1(m, n) | | duration | | |
| signal | | light- | pixel-data | pixel light- |
| | | intensity | voltage- | emission |
| | | reset | setting | duration Tem |
| | | duration | duration | |
| | | Trs | Tdat_wrt | |
| Internal- | NDq(m, n) | Vini | | Vdd- |
| node | | | | (Vdata(m, n)- |
| | | | | Vth) |
| | NDg(m, n) | Vini | Vdata(m, n) | Vdd- |
| | | | | (Vdata(m, n)- |
| | | | | Vth) |
| | NDs(m, n) | Vini | (Vdata(m, n)- | Vdd |
| | | | Vth) | |

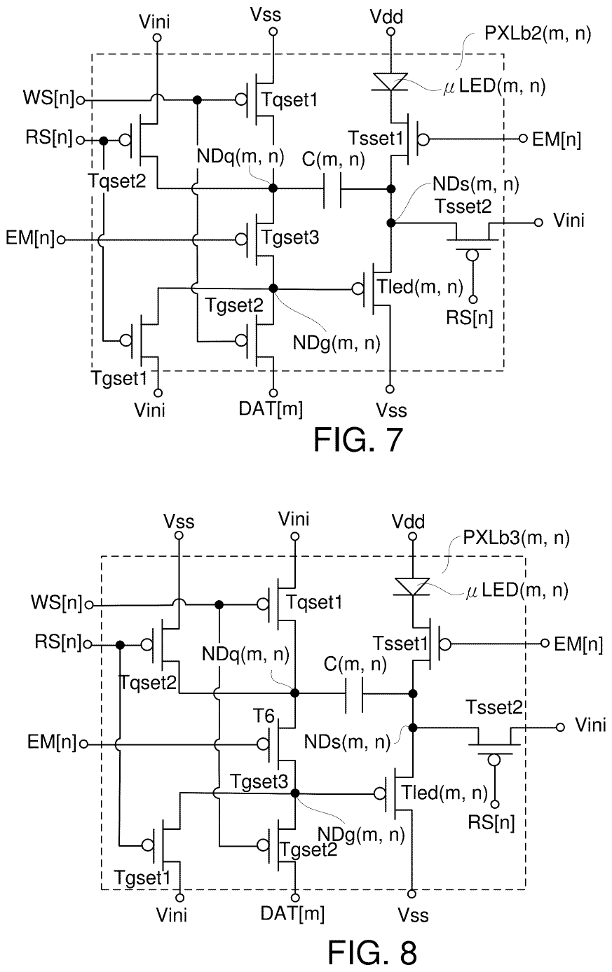

Based on the illustrations above, the embodiments of the pixel circuits PXLb2(m, n) and PXLb3(m, n) shown in FIGS. 7 and 8 provide two other approaches to connect the source terminals S of the internal-node setting transistors Tqset1 and Tqset2. Similarly, the waveforms of the reset gate-line signal RS[n], the pixel-data setting gate-line signal WS[n], the data-line signal DAT[n], and the light-emission activate gate-line signal EM[n] are identical to those illustrated in FIGS. 3 and 4, and the illustrations are omitted. The voltage of the internal-node NDq(m, n) during the light-intensity reset duration Trs and the pixel-data voltage-setting duration Tdat_wrt in the embodiments shown in FIGS. 7 and 8 is different from that of the embodiments shown in FIGS. 3 and 4. The voltages of the internal-nodes NDq(m, n), NDg(m, n), and NDs(m, n) are listed in a table.

FIG. 7 is a schematic diagram illustrating the embodiment of the pixel circuit PXLb2(m, n) according to the concept of the present disclosure. In FIG. 7, the source terminal S of the internal-node setting transistor Tqset1 is electrically connected to the ground voltage line Vss, and the source terminal S of the internal-node setting transistor Tqset2 is electrically connected to the preset voltage line Vini. The voltages of the internal-nodes NDq(m, n), NDg(m, n), and NDs(m, n) of the pixel circuit PXLb2(m, n) during the light-intensity reset duration Trs, the pixel-data voltage-setting duration Tdat_wrt, and the pixel light-emission duration Tem in FIG. 7 are summarized in Table 3.

TABLE 3

| pixel circuit | | | | |
|---|---|---|---|---|
| PXLb2(m, n) | | duration | | |
| signal | | light- | pixel-data | pixel light- |
| | | intensity | voltage-setting | emission |
| | | reset | duration | duration |
| | | duration | Tdat_wrt | Tem |
| | | Trs | | |
| internal- | NDq(m, n) | Vini | Vss | Vdd- |
| node | | | | (Vdata(m, n)- |
| | | | | Vth) |
| | NDg(m, n) | Vini | Vdata(m, n) | Vdd- |
| | | | | (Vdata(m, n)- |
| | | | | Vth) |
| | NDs(m, n) | Vini | (Vdata(m, n)- | Vdd |
| | | | Vth) | |

FIG. 8 is a schematic diagram illustrating the embodiment of the pixel circuit PXLb3(m, n) according to the concept of the present disclosure. In FIG. 8, the source terminal S of the internal-node setting transistor Tqset1 is electrically connected to the preset voltage line Vini, and the source terminal S of the internal-node setting transistor Tqset2 is electrically connected to the ground voltage line Vss. The voltages of the internal-nodes NDq(m, n), NDg(m, n), and NDs(m, n) of the pixel circuit PXLb3(m, n) during the light-intensity reset duration Trs, the pixel-data voltage-setting duration Tdat_wrt, and the pixel light-emission duration Tem in FIG. 8 are summarized in Table 4.

TABLE 4

| pixel circuit | | | | |
|---|---|---|---|---|
| PXLb3(m, n) | | duration | | |
| signal | | light- | pixel-data | pixel light- |
| | | intensity | voltage-setting | emission |
| | | reset | duration | duration |
| | | duration | Tdat_wrt | Tem |
| | | Trs | | |
| internal- | NDq(m, n) | Vss | Vini | Vdd- |
| node | | | | (Vdata(m, n)-Vth) |
| | NDg(m, n) | Vini | Vdata(m, n) | Vdd- |
| | | | | (Vdata(m, n)-Vth) |
| | NDs(m, n) | Vini | (Vdata(m, n)- | Vdd |
| | | | Vth) | |

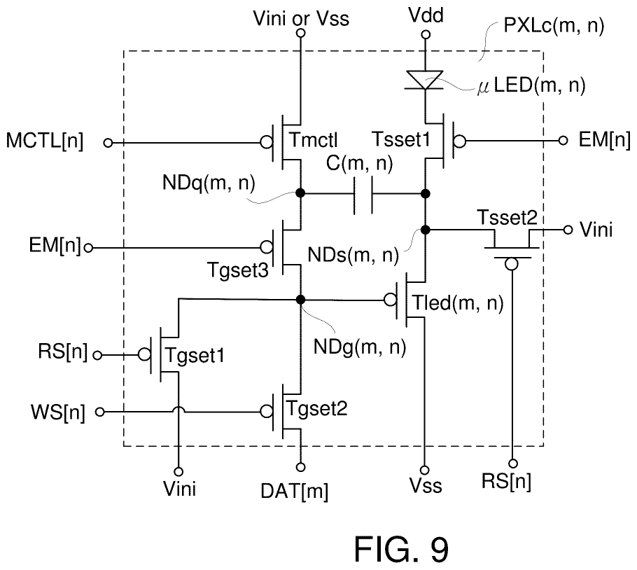

To reduce the number of transistors in the pixel circuit PXL(m, n), another embodiment, according to the concept of the present disclosure, is provided in FIG. 9. FIG. 9 is a schematic diagram illustrating the embodiment of the pixel circuit PXLc(m, n) according to the concept of the present disclosure.

As the internal components of the pixel circuit PXLc(m, n) are similar to those in FIGS. 3, 6A, 7, and 8, related illustrations are omitted. Compared with FIGS. 3, 6A, 7, and 8, the internal-node setting transistor Tqset2 is no longer used in FIG. 9, and the pixel-data setting gate-line signal WS[n] is no longer utilized to control the internal-node setting transistor Tqset1. Instead, the control-combined gate-line signal MCTL[n] is adopted to control the control-combined transistor Tmctl. The voltage of the control-combined gate-line signal MCTL[n] is between the low gate-control voltage VGL and the high gate-control voltage VGH.

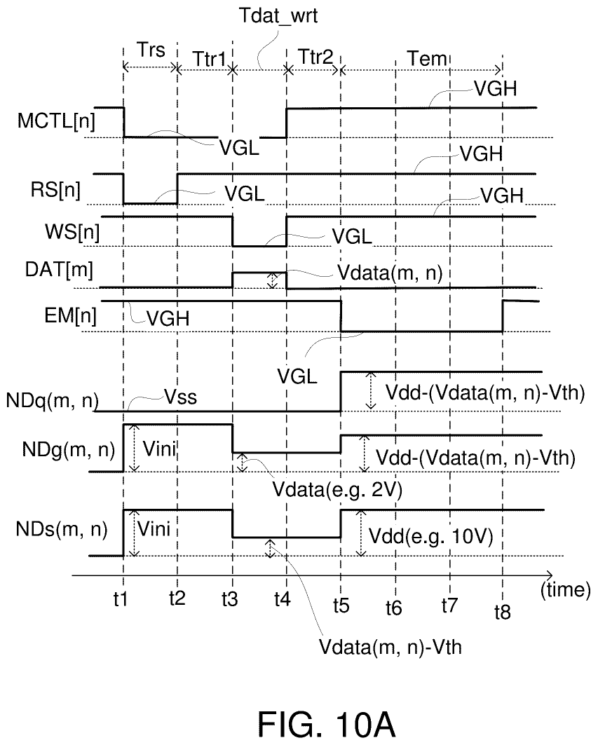

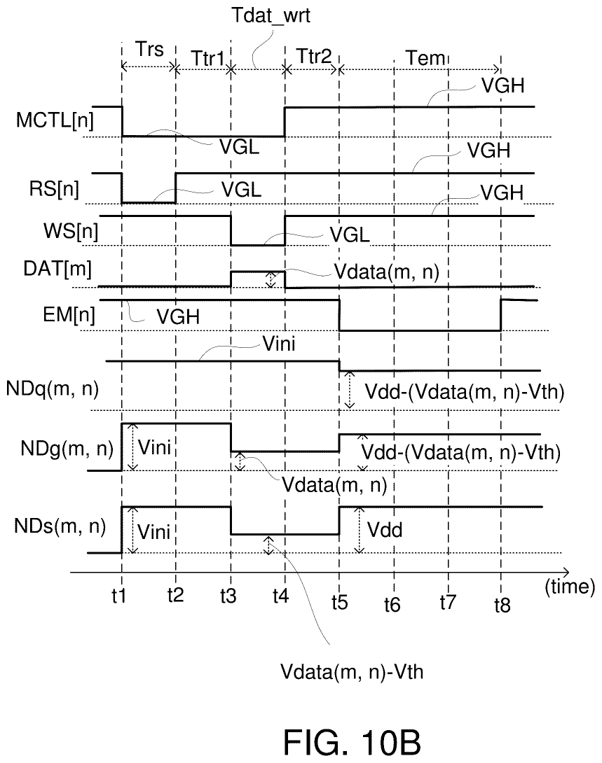

In the pixel circuit PXLc(m, n), the source terminal S of the control-combined transistor Tmctl can be electrically connected to the ground voltage line Vss (see FIG. 10A) or the preset voltage line Vini (see FIG. 10B), the gate terminal G of the control-combined transistor Tmctl is electrically connected to the control-combined gate-line MCTL[n], and the drain terminal D of the control-combined transistor Tmctl is electrically connected to the internal-node NDq(m, n). The waveforms corresponding to the scenarios when the source terminal S of the control-combined transistor Tmctl is respectively electrically connected to the ground voltage line Vss and the preset voltage line Vini are shown in FIGS. 10A and 10B.

FIGS. 10A and 10B are waveform diagrams corresponding to the scenarios assuming that the source terminal S of the control-combined transistor Tmctl in FIG. 9 is electrically connected to the ground voltage line Vss and the preset voltage line Vini, respectively. In FIGS. 10A and 10B, the horizontal axis represents time. From top to bottom, the vertical axis represents the voltages of the signals received from the timing control circuit, including the control-combined gate-line signal MCTL[n], the reset gate-line signal RS[n], the pixel-data setting gate-line signal WS[n], the data-line signal DAT[m], and the light-emission activate gate-line signal EM[n], together with the voltages of the internal-nodes NDq(m, n), NDg(m, n), and NDs(m, n) in the pixel circuit PXLc(m, n). Compared with FIG. 4, the timing control circuit must transmit the additional control-combined gate-line signal MCL[n] to the pixel circuit PXLc(m, n) in FIG. 9.

The voltage of the control-combined gate-line signal MCL[n]remains at the high gate-control voltage VGH (MCL[n]=VGH) before the time point t1. The voltage of the control-combined gate-line signal MCL[n]changes from the high gate-control voltage VGH to the low gate-control voltage VGL (MCL[n]=VGH+VGL) at the time point t1, and remains at the low gate-control voltage VGL (MCL[n]=VGL) between the time point t1 and the time point t4. Besides, the voltage of the control-combined gate-line signal MCL[n]changes again from the low gate-control voltage VGL to the high gate-control voltage VGH (MCL[n]=VGL→VGH) at time point t4. The duration (between the time point t1 to the time point t4) when the voltage of the control-combined gate-line signal MCL[n] is equivalent to the low gate-control voltage VGL (MCL[n]=VGL) covers the duration (between the time point t1 to the time point t2) when the voltage of the reset gate-line signal RS[n] is equivalent to the low gate-control voltage VGL (RS[n]=VGL), the duration (between the time point t3 to the time point t4) when the pixel-data setting gate-line signal WS[n] is equivalent to the low gate-control voltage VGL (WS[n]=VGL), and the transition duration Ttr1 (between the time point t2 to the time point t3) in between.

Alternatively speaking, the duration when the voltage of the setting the gate-line signal MCTL[n] is equivalent to the low gate-control voltage VGL (MCL[n]=VGL) covers the light-intensity reset duration Trs, the transition duration Ttr1, and the pixel-data voltage-setting duration Tdat_wrt. With such a design, the voltage-setting relationship that the voltage of the internal-node NDq(m, n) is set in response to the control-combined transistor Tmctl being switched on in response to the low gate-control voltage VGL at the control-combined gate-line MCTL[n](MCTL[n]=VGL) during the light-intensity reset duration Trs in FIG. 9 is similar to the voltage-setting relationship that the voltage of the internal-node NDq(m, n) is set in response to the internal-node setting transistor Tqset2 being switched on in response to the low gate-control voltage VGL at the reset gate-line RS[n](RS[n]=VGL) during the light-intensity reset duration Trs in FIG. 4. Moreover, the voltage-setting relationship that the voltage of the internal-node NDq(m, n) is set by the control-combined transistor Tmctl being switched on in response to the low gate-control voltage VGL at the control-combined gate-line MCTL[n](MCTL[n]=VGL) during the pixel-data voltage-setting duration Tdat_wrt in FIG. 9 is similar to the voltage-setting relationship that the voltage of the internal-node NDq(m, n) is set in response to the internal-node setting transistor Tqset1 being switched on in response to the low gate-control voltage VGL at the pixel-data setting gate-line WS[n](WS[n]=VGL) during the pixel-data voltage-setting duration Tdat_wrt in FIG. 4.

Please refer to FIGS. 4, 10A, and 10B together. The waveforms and timing sequences related to the reset gate-line signal RS[n], the pixel-data setting gate-line signal WS[n], the data-line signal DAT[m], and the light-emission activate gate-line signal EM[n]transmitted by the timing control circuit in FIGS. 10A and 10B are similar to those in FIG. 4. Detailed explanations about their waveforms are not redundantly illustrated.

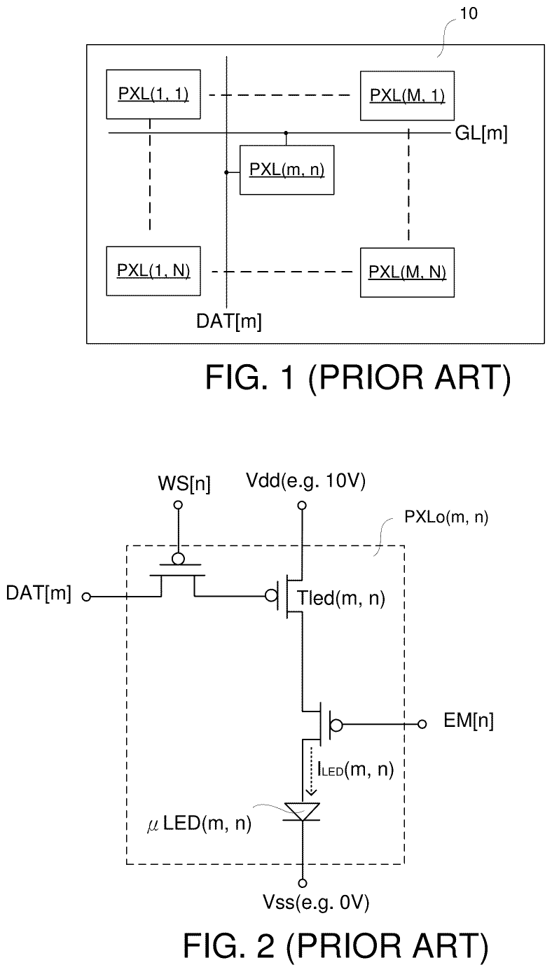

As shown in FIGS. 10A and 10B, the voltages of the signals during the light-intensity reset duration Trs, the pixel-data voltage-setting duration Tdat_wrt, and the pixel light-emission duration Tem are summarized in Table 5. Please refer to Table 5 and FIGS. 9, 10A, and 1 GB together.

TABLE 5

| pixel circuit PXLc(m, n) | | duration | | |
|---|---|---|---|---|
| signal | | light- | pixel-data | pixel light- |
| | | intensity | voltage- | emission |
| | | reset | setting | duration |
| | | duration | duration | Tem. |
| | | Trs | Tdat_wrt | |
| signal | control- | VGL | | VGH |
| received | combined | | | |
| from the | gate-line | | | |
| timing | signal MCTL[n] | | | |
| control | reset gate- | VGL | VGH | |
| circuit | line signal | | | |
| | RS[n] | | | |
| | pixel-data | VGH | VGL | VGH |
| | setting gate- | | | |
| | line signal | | | |
| | WS[n] | | | |
| | data-line | Vss | Vdata(m, n) | Vss |
| | signal DAT[m] | | | |
| | light-emission | VGH | | VGL |
| | activate | | | |
| | gate-line | | | |
| | signal EM[n] | | | |
| internal- | NDq(m, n) | Vss | | Vdd- |
| node | in FIG. 10A | | | (Vdata(m, n)- |
| | | | | Vth) |
| | NDq(m, n) | Vini | | Vdd- |
| | in FIG. 10B | | | (Vdata(m, n)- |
| | | | | Vth) |
| | NDg(m, n) | Vini | Vdata(m, n) | Vdd- |
| | | | | (Vdata(m, n)- |
| | | | | Vth) |
| | internal-node | Vini | (Vdata(m, | Vdd |
| | NDs(m, n) | | n)-Vth) | |

According to the concept of the present disclosure, the supply voltage Vdd might be greater than the preset voltage Vini (Vdd>Vini), smaller than the preset voltage Vini (Vdd<Vini), or equivalent to the preset voltage Vini (Vdd=Vini). As the voltage values of the supply voltage Vdd and the preset voltage Vini can be equivalent (Vdd=Vini) in this type of embodiment, the preset voltage (line) Vini can be replaced with the supply voltage (line) Vdd in practical applications.

However, as the supply voltage Vdd is a common voltage source provided to M*N pixel circuits PXL(1, 1)˜PXL(M, N), the N pixel currents I_{LED}(1, 1)˜I_{LED}(M, N) flowing from the supply voltage Vdd to the pixel circuits PXL(1, 1)˜PXL(M, N) might cause minor voltage drop of the supply voltage Vdd. Even if the voltage value of the supply voltage Vdd and the voltage value of the preset voltage Vini are designed to be equivalent (Vdd=Vini), the stability of the supply voltage Vdd is still slightly worse than the stability of the preset voltage Vini as the preset voltage Vini is provided by a separate and individual source. Alternatively, fluctuations might occur at the supply voltage Vdd so that the voltage value (for example, 10V) of the supply voltage Vdd is unstable.

In the case that the preset voltage (line) Vini is replaced by the supply voltage (line) Vdd, the maximum voltage value (max{Vdata(m, n)}) of the pixel-data setting voltage Vdata(m, n) must be lower than the minimum voltage value (min{Vdd}) of the supply voltage Vdd even if the actual voltage value of the supply voltage Vdd fluctuates. That is, max{Vdata(m, n)}<min{Vdd}. For example, assuming that the supply voltage Vdd fluctuates and drops from the default voltage value (for example, 10V) to 8V (min{Vdd}=8V) during the x-th frame period Tframe[x], the maximum voltage value (max{Vdata(m, n)}) of the pixel-data setting voltage Vdata(m, n) is set to be 6V (max{Vdata(m, n)}=6V).

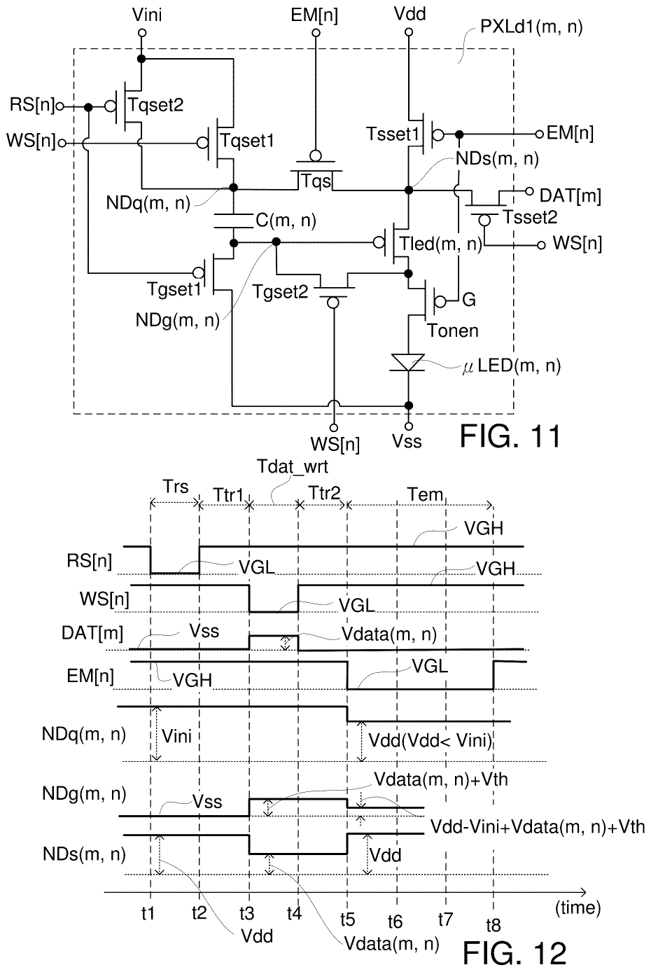

FIGS. 11-15 demonstrate that another PAM approach is utilized to control the pixel circuit according to another embodiment of the present disclosure. FIG. 11 is a schematic diagram illustrating the embodiment of the pixel circuit PXLd1(m, n) according to the concept of the present disclosure. The pixel circuit PXLa(m, n) is electrically connected to the ground voltage line Vss, the supply voltage line Vdd, the preset voltage line Vini, the pixel-data setting gate-line WS[n], the reset gate-line RS[n], the light-emission activate gate-line EM[n], and the data-line DAT[m]. The supply voltage line Vdd provides the supply voltage Vdd (for example, Vdd=10V), and the ground voltage line Vss provides the ground voltage Vss (for example, Vss=10V). In this embodiment, the preset voltage line Vini provides the preset voltage Vini, with a voltage value (for example, Vini=12V) slightly higher than the voltage value of the supply voltage Vdd.

The pixel-data setting gate-line signal WS[n], the reset gate-line signal RS[n], and the light-emission activate gate-line signal EM[n] are logic control signals generated by the timing control circuit. The voltages of the pixel-data setting gate-line signal WS[n], the reset gate-line signal RS[n], and the light-emission activate gate-line signal EM[n] are between the low gate-control voltage VGL (for example, VGL=−5V) and the high gate-control voltage VGH (for example, VGH=15V).

The pixel circuit PXLd1(m, n) includes a capacitor C(m, n), a μLED(m, n), internal-node setting transistors Tqset1, Tqset2, Tsset1, Tsset2, Tgset1, and Tgset2, an internal-node bridging transistor Tqs, a light-emission activate transistor Tonen, and a light-intensity control transistor Tled(m, n). The internal-node setting transistors Tgset1 and Tgset2 are utilized to set the voltage of the internal-node NDg(m, n), the internal-node setting transistors Tqset1 and Tqset2 are utilized to set the voltage of the internal-node NDq(m, n), and the internal-node setting transistors Tsset1 and Tsset2 are utilized to set the voltage of the internal-node NDs(m, n). The connections between these components are illustrated as follows.

The two terminals of the capacitor C(m, n) are respectively electrically connected to the internal-node NDq(m, n) and the internal-node NDg(m, n). The anode of the μLED(m, n) is electrically connected to the drain terminal D of the light-emission activate transistor Tonen, and the cathode of the μLED(m, n) is electrically connected to the ground voltage line Vss. The source terminal S of the internal-node setting transistor Tqset1 is electrically connected to the preset voltage line Vini, the gate terminal G of the internal-node setting transistor Tqset1 is electrically connected to the pixel-data setting gate-line WS[n], and the drain terminal D of the internal-node setting transistor Tqset1 is electrically connected to the internal-node NDq(m, n). The source terminal S of the internal-node setting transistor Tqset2 is electrically connected to the preset voltage line Vini, the gate terminal G of the internal-node setting transistor Tqset2 is electrically connected to the reset gate-line RS[n], and the drain terminal D of the internal-node setting transistor Tqset2 is electrically connected to the internal-node NDq(m, n). The source terminal S of the internal-node bridging transistor Tqs is electrically connected to the internal-node NDs(m, n), the gate terminal G of the internal-node bridging transistor Tqs is electrically connected to the light-emission activate gate-line EM[n], and the drain terminal D of the internal-node bridging transistor Tqs is electrically connected to the internal-node NDq(m, n). The source terminal S of the internal-node setting transistor Tsset1 is electrically connected to the supply voltage line Vdd, the gate terminal G of the internal-node setting transistor Tsset1 is electrically connected to the light-emission activate gate-line EM[n], and the drain terminal D of the internal-node setting transistor Tsset1 is electrically connected to the internal-node NDs(m, n). The source terminal S of the internal-node setting transistor Tsset2 is electrically connected to the data-line DAT[m], the gate terminal G of the internal-node setting transistor Tsset2 is electrically connected to the pixel-data setting gate-line WS[n], and the drain terminal D of the internal-node setting transistor Tsset2 is electrically connected to the internal-node NDs(m, n). The source terminal S of the light-intensity control transistor Tled(m, n) is electrically connected to the internal-node NDs(m, n), the gate terminal G of the light-intensity control transistor Tled(m, n) is electrically connected to the internal-node NDg(m, n), and the drain terminal D of the light-intensity control transistor Tled(m, n) is electrically connected to the drain terminal D of the internal-node setting transistor Tgset2 and the source terminal S of the light-emission activate transistor Tonen. The gate terminal G of the light-emission activate transistor Tonen is electrically connected to the light-emission activate gate-line EM[n], and the drain terminal D of the light-emission activate transistor Tonen is electrically connected to the anode of the μLED(m, n). The source terminal S of the internal-node setting transistor Tgset2 is electrically connected to the internal-node NDg(m, n), and the gate terminal G of the internal-node setting transistor Tgset2 is electrically connected to the pixel-data setting gate-line WS[n]. The source terminal S of the internal-node setting transistor Tgset1 is electrically connected to the internal-node NDg(m, n), the gate terminal G of the internal-node setting transistor Tgset1 is electrically connected to the reset gate-line RS[n], and the drain terminal D of the internal-node setting transistor Tgset1 is electrically connected to the ground voltage line Vss.

In FIG. 11, the voltage of the internal-node NDq(m, n) is changed with the ON/OFF states of the internal-node setting transistors Tqset1 and Tqset2 and the ON/OFF state of the internal-node bridging transistor Tqs. The voltage of the internal-node NDs(m, n) is changed with the ON/OFF states of the internal-node setting transistors Tsset1 and Tsset2. The voltage of the internal-node NDg(m, n) is changed with the ON/OFF states of the internal-node setting transistors Tgset1 and Tgset2. The voltage of the internal-node NDg(m, n) is utilized to control the ON/OFF state of the light-intensity control transistor Tled(m, n).

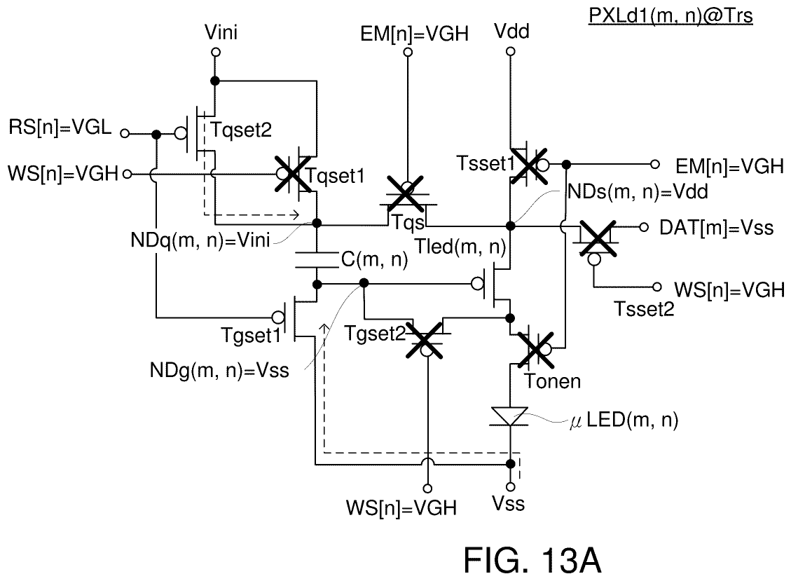

FIG. 12 is a waveform diagram corresponding to the pixel circuit PXLd1(m, n) embodiment in FIG. 11. In this diagram, the horizontal axis represents time. From top to bottom, the vertical axis represents the voltages of the signals received from the timing control circuit, including the reset gate-line signal RS[n], the pixel-data setting gate-line signal WS[n], the data-line signal DAT[m], and the light-emission activate gate-line signal EM[n], together with the voltages of the internal-nodes NDq(m, n), NDg(m, n), and NDs(m, n) in the pixel circuit PXLd1(m, n). The timing control circuit controls the pixel circuit PXLd1(m, n) to emit light between the time point t1 and the time point t8. The time durations between the successive points are equivalent. How the timing control circuit generates the reset gate-line signal RS[n], the pixel-data setting gate-line signal WS[n], the data-line signal DAT[m], and the light-emission activate gate-line signal EM[n] in this type of embodiment are similar to those illustrated in FIG. 4, so the detailed illustrations are omitted.

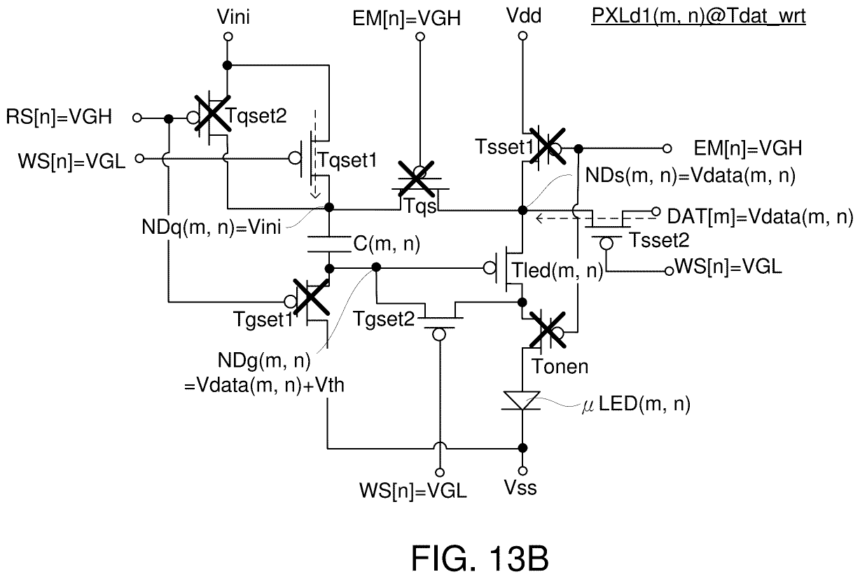

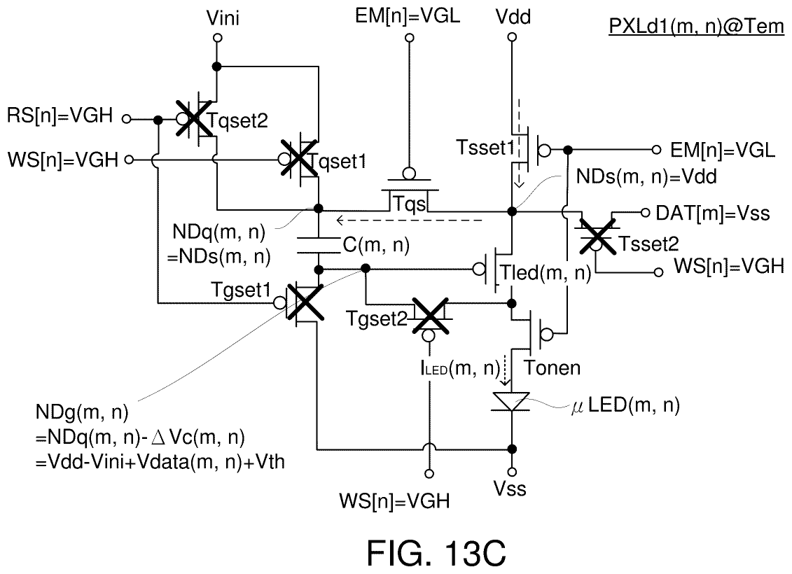

FIG. 13A is a schematic diagram illustrating the circuit state of the pixel circuit PXLd1(m, n) in FIG. 11 when the pixel circuit PXLd1(m, n) operates during the light-intensity reset duration Trs. Please refer to FIGS. 11, 12 and 13A together.

During the light-intensity reset duration Trs (the duration between the time point t1 and the time point t2 in FIG. 12), the voltage of the reset gate-line signal RS[n] is equivalent to the low gate-control voltage VGL (RS[n]=VGL), the voltage of the pixel-data setting gate-line signal WS[n] is equivalent to the high gate-control voltage VGH (WS[n]=VGH), the voltage of the data-line signal DAT[m] is equivalent to the ground voltage Vss (DAT[m]=Vss), and the voltage of the light-emission activate gate-line signal EM[n] is equivalent to the high gate-control voltage VGH (EM[n]=VGH). Consequentially, the internal-node setting transistors Tgset1 and Tqset2 are switched on in response to the low gate-control voltage VGL at the reset gate-line signal RS[n](RS[n]=VGL), the internal-node setting transistors Tgset2, Tqset1, and Tsset2 are switched off in response to the high gate-control voltage VGH at the pixel-data setting gate-line signal WS[n](WS[n]=VGH), and the internal-node bridging transistor Tqs, the internal-node setting transistor Tsset1, and the light-emission activate transistor Tonen are switched off in response to the high gate-control voltage VGH at the light-emission activate gate-line signal EM[n](EM[n]=VGH). How the voltages of the internal-nodes NDq(m, n), NDg(m, n), and NDs(m, n) during the light-intensity reset duration Trs are affected by the ON/OFF states of the internal-node setting transistors Tqset1, Tqset2, Tsset1, Tsset2, Tgset1, and Tgset2, the internal-node bridging transistor Tqs, the light-emission activate transistor Tonen, and the light-intensity control transistor Tled(m, n) is illustrated below, together with details about how the ON/OFF state of the light-intensity control transistor Tled(m, n) is affected by the voltages of the internal-nodes NDg(m, n) and NDs(m, n).

During the light-intensity reset duration Trs, the internal-node setting transistor Tqset2 at the ON state conducts the preset voltage Vini to the internal-node NDq(m, n). Meanwhile, the internal-node setting transistor Tqset1 at the OFF state does not affect the voltage of the internal-node NDq(m, n). Thus, the voltage of the internal-node NDq(m, n) is equivalent to the preset voltage Vini (NDq(m, n)=Vini) during the light-intensity reset duration Trs. Besides, during the light-intensity reset duration Trs, the voltage of the internal-node NDg(m, n) is not affected by the internal-node setting transistor Tgset2 at the OFF state, and the internal-node setting transistor Tgset1 at the ON state conducts the ground voltage Vss to the internal-node NDg(m, n). Thus, the voltage of the internal-node NDg(m, n) is equivalent to the ground voltage Vss (NDg(m, n)=Vss) during the light-intensity reset duration Trs.

Moreover, the internal-node setting transistor Tsset1 and Tsset2 and the internal-node bridging transistor Tqs at the OFF state do not affect the voltage of the internal-node NDs(m, n) during the light-intensity reset duration Trs. The voltage of the internal-node NDs(m, n) remains unchanged during the light-intensity reset duration Trs. To be more specific, the voltage of the internal-node NDs(m, n) remains as the supply voltage Vdd (NDs(m, n)=Vdd) during the pixel light-emission duration Tem in the (x−1)-th frame period Tframe[x−1].

The source terminal S of the light-intensity control transistor Tled(m, n) is electrically connected to the internal-node NDs(m, n), and the gate terminal G of the light-intensity control transistor Tled(m, n) is electrically connected to the internal-node NDg(m, n). According to the above illustrations, the voltage of the internal-node NDs(m, n) during the light-intensity reset duration Trs is equivalent to the supply voltage Vdd (NDs(m, n)=Vdd), the same as its voltage value during the (x−1)-th frame period Tframe[x−1]. Meanwhile, the voltage of the internal-node NDg(m, n) is equivalent to the ground voltage Vss (NDg(m, n)=Vss). Thus, the light-intensity control transistor Tled(m, n) can be switched on because the voltage difference Vgs between its gate terminal G and source terminal S is smaller than the threshold voltage Vth (Vgs=Vss-Vdd<Vth). However, no pixel current I_{LED}(m, n) flows through the light-intensity control transistor Tled(m, n) and the μLED(m, n) because both the light-emission activate transistor Tonen and the internal-node setting transistor Tsset1 are switched off. Thus, the μLED(m, n) does not emit light during the light-intensity reset duration Trs.

FIG. 13B is a schematic diagram illustrating the circuit state of the pixel circuit PXLd1(m, n) in FIG. 11 when the pixel circuit PXLd1(m, n) operates during the pixel-data voltage-setting duration Tdat_wrt. Please refer to FIGS. 11, 12, and 13B together.

During the pixel-data voltage-setting duration Tdat_wrt (that is, the duration between the time point t3 and the time point t4 in FIG. 12), the voltage of the reset gate-line signal RS[n] is equivalent to the high gate-control voltage VGH (RS[n]=VGH), the voltage of the pixel-data setting gate-line signal WS[n] is equivalent to the low gate-control voltage VGL (WS[n]=VGL), the voltage of the data-line signal DAT[m] is equivalent to the pixel-data setting voltage Vdata(m, n) (DAT[m]=Vdata(m, n)), and the voltage of the light-emission activate gate-line signal EM[n] is equivalent to the high gate-control voltage VGH (EM[n]=VGH).

Consequentially, the internal-node setting transistors Tgset1 and Tqset2 are switched off in response to the high gate-control voltage VGH at the reset gate-line signal RS[n](RS[n]=VGH), the internal-node setting transistors Tgset2, Tqset1, and Tsset2 are switched on in response to the low gate-control voltage VGL at the pixel-data setting gate-line signal WS[n](WS[n]=VGL), and the internal-node bridging transistor Tqs, the internal-node setting transistor Tsset1, and the light-emission activate transistor Tonen are switched off in response to the high gate-control voltage VGH at the light-emission activate gate-line signal EM[n](EM[n]=VGH). Based on the ON/OFF states of the internal-node setting transistors Tqset1, Tqset2, Tsset1, Tsset2, Tgset1, and Tgset2, the internal-node bridging transistor Tqs, the light-emission activate transistor Tonen, and the light-intensity control transistor Tled(m, n), the voltages of the internal-nodes NDq(m, n), NDg(m, n), and NDs(m, n) during the pixel-data voltage-setting duration Tdat_wrt are affected. Details about how the voltages of the internal-nodes NDq(m, n), NDg(m, n), and NDs(m, n) during the pixel-data voltage-setting duration Tdat_wrt are affected by their related internal-node setting transistors are sequentially illustrated. Details about how the ON/OFF state of the light-intensity control transistor Tled(m, n) is affected by the internal-nodes NDg(m, n) and NDs(m, n) are illustrated as well.

During the pixel-data voltage-setting duration Tdat_wrt, the internal-node setting transistor Tqset1 at the ON state conducts the preset voltage Vini to the internal-node NDq(m, n). Meanwhile, the internal-node setting transistor Tqset2 at the OFF state does not affect the voltage of the internal-node NDq(m, n). Thus, the voltage of the internal-node NDq(m, n) is equivalent to the preset voltage Vini (NDs(m, n)=Vini) during the pixel-data voltage-setting duration Tdat_wrt. Moreover, the internal-node setting transistor Tgset1 at the OFF state does not affect the voltage of the internal-node NDg(m, n) during the pixel-data voltage-setting duration Tdat_wrt. Meanwhile, the internal-node setting transistor Tgset2 at the ON state conducts the voltage of the internal-node NDg(m, n) at its source terminal S to its drain terminal D. As the source terminal S of the internal-node setting transistor Tsset2 is electrically connected to the data-line DAT[m], and the drain terminal D of the internal-node setting transistor Tsset2 is electrically connected to the internal-node NDs(m, n), the internal-node setting transistor Tsset2 at the ON state conducts the pixel-data setting voltage Vdata(m, n) at the data-line DAT[m] to the internal-node NDs(m, n).

The source terminal S of the light-intensity control transistor Tled(m, n) is electrically connected to the internal-node NDs(m, n), the gate terminal G of the light-intensity control transistor Tled(m, n) is electrically connected to the internal-node NDg(m, n), and the drain terminal D of the light-intensity control transistor Tled(m, n) is electrically connected to the drain terminal D of the internal-node setting transistor Tgset2. As the source terminal S of the light-intensity control transistor Tled(m, n) is electrically connected to the internal-node NDs(m, n), the voltage of the source terminal S of the light-intensity control transistor Tled(m, n) is equivalent to the pixel-data setting voltage Vdata(m, n). That is, NDs(m, n)=Vdata(m, n).

During the pixel-data voltage-setting duration Tdat_wrt, the light-intensity control transistor Tled(m, n) operates in the saturation region. As the light-intensity control transistor Tled(m, n) operates in the saturation region, the voltage difference Vgs between the gate terminal G and the source terminal S of the light-intensity control transistor Tled(m, n) is equivalent to the threshold voltage Vth of the light-intensity control transistor Tled(m, n) (for example, 1.5V). According to the above illustrations, the voltage of the gate terminal G of the light-intensity control transistor Tled(m, n) is equivalent to the pixel-data setting voltage Vdata(m, n). Moreover, the voltage difference Vgs between the gate terminal G and the source terminal S is equivalent to the threshold voltage Vth (Vgs=Vth). Thus, the voltage of the internal-node NDg(m, n) during the pixel-data voltage-setting duration Tdat_wrt can be calculated.

During the pixel-data voltage-setting duration Tdat_wrt, the voltage of the internal-node NDg(m, n) is equivalent to the summation (Vdata(m, n)+Vth) of the pixel-data setting voltage Vdata(m, n) and the threshold voltage Vth of the light-intensity control transistor Tled(m, n). That is, NDg(m, n)=(Vdata(m, n)+Vth). As the threshold voltage Vth of the light-intensity control transistor Tled(m, n) has a negative voltage value, the voltage of the internal-node NDg(m, n) is lower than the voltage of the internal-node NDs(m, n) during the pixel-data voltage-setting duration Tdat_wrt. That is, NDg(m, n)=(Vdata(m, n)+Vth)<NDs(m, n)=Vdata(m, n).

As the emission enablement transistor Tonen and the internal-node setting transistor Tsset1 are switched off in response to the high gate-control voltage VGH (EM[n]=VGH) at the light-emission activate gate-line signal EM[n], there is no pixel current I_{LED}(m, n) flowing through the μLED(m, n). Thus, the μLED(m, n) still does not emit light during the pixel-data voltage-setting duration Tdat_wrt.

The two terminals of the capacitor C(m, n) are respectively electrically connected to the internal-node NDq(m, n) and the internal-node NDg(m, n). Thus, the voltage difference ΔVc(m, n) across the capacitor C(m, n) can be represented as the voltage difference (NDq(m, n)-NDg(m, n)) between the voltage of the internal-node NDq(m, n) and the voltage of the internal node NDg(m, n). In FIG. 13B, the voltage difference ΔVc(m, n) across the capacitor C(m, n) can be represented by equation 3.

$$\begin{matrix}ΔV c ( m , n ) = NDq ( m , n ) - NDg ( m , n ) \\ = V ini - ( V data ( m , n ) + V th ) \\ = V ini - V data ( m , n ) - V th\end{matrix} \qquad ( equation 3 )$$

FIG. 13C is a schematic diagram illustrating the circuit state of the pixel circuit PXLd1(m, n) in FIG. 11 when the pixel circuit PXLd1(m, n) operates during the pixel light-emission duration Tem. Please refer to FIGS. 11, 12, and 13C together.

During the pixel light-emission duration Tem (that is, the duration between time point t5 and the time point t8 in FIG. 12), the voltage of the reset gate-line signal RS[n] is equivalent to the high gate-control voltage VGH (RS[n]=VGH), the voltage of the pixel-data setting gate-line signal WS[n] is equivalent to the high gate-control voltage VGH (WS[n]=VGH), the voltage of the data-line signal DAT[n] is equivalent to the ground voltage Vss (DAT[m]=Vss), and the voltage of the light-emission activate gate-line signal EM[n] is equivalent to the low gate-control voltage VGL (EM[n]=VGL). Consequentially, the internal-node setting transistors Tgset1 and Tqset2 are switched off to the high gate-control voltage VGH at the reset gate-line RS[n](RS[n]=VGH), the internal-node setting transistors Tgset2, Tqset1, and Tsset2 are switched off in response to the high gate-control voltage VGH at the pixel-data setting gate-line WS[n](WS[n]=VGH), and the internal-node bridging transistor Tqs, the internal-node setting transistor Tsset1, and the light-emission activate transistor Tonen are switched off in response to the high gate-control voltage VGH at the light-emission activate gate-line EM[n](EM[n]=VGL). Based on the ON/OFF states of the internal-node setting transistors Tqset1, Tqset2, Tsset1, Tsset2, Tgset1, and Tgset2, the internal-node bridging transistor Tqs, the light-emission activate transistor Tonen, and the light-intensity control transistor Tled(m, n), details about how the voltages of the internal-nodes NDq(m, n), NDg(m, n), and NDs(m, n) are affected by their corresponding internal-node setting transistors during the pixel light-emission duration Tem are illustrated. Details about how the voltages of the internal-nodes NDg(m, n) and NDs(m, n) affect the ON/OFF state of the light-intensity control transistor Tled(m, n) are illustrated as well.

During the pixel light-emission duration Tem, the voltage of the internal-node NDq(m, n) is unaffected by the internal-node setting transistors Tqset1 and Tqset2 at the OFF states. Meanwhile, the voltage of the internal-node NDq(m, n) is equivalent to the voltage of the internal-node NDs(m, n) because the internal-node bridging transistor Tqs is switched on. That is, NDq(m, n)=NDs(m, n).

During the pixel light-emission duration Tem, the internal-node setting transistor Tsset2 at the OFF state does not affect the voltage of the internal-node NDs(m, n). At this stage, the voltage of the internal-node NDs(m, n) is equivalent to the supply voltage Vdd (NDs(m, n)=Vdd) because the internal-node setting transistor Tsset1 is switched on. The voltage of the internal-node NDs(m, n) (NDs(m, n)=Vdd) during the pixel light-emission duration Tem in the x-th frame period Tframe[x]continues to remain unchanged during the light-intensity reset duration Trs and the transition period Ttr1 in the (x+1)-th frame period Tframe[x+1].

During the pixel light-emission duration Tem, the internal-node setting transistors Tgset1 and Tgset2 at the OFF state do not affect the voltage of the internal-node NDg(m, n). At this stage, the voltage of the internal-node NDg(m, n) is equivalent to the voltage difference that the voltage of the internal-node NDq(m, n) deducts the voltage difference ΔVc(m, n) across the capacitor C(m, n). That is, NDg(m, n)=[NDq(m, n)−ΔVc(m, n)]. The voltage of the internal-node NDq(m, n) is equivalent to the voltage of the internal-node NDs(m, n) (NDq(m, n)=NDs(m, n)), and the voltage of the internal-node NDs(m, n) is equivalent to the supply voltage Vdd (NDs(m, n)=Vdd). That is, NDq(m, n)=NDs(m, n)=Vdd. Therefore, the voltage of the internal-node NDg(m, n) can be calculated by equation 4.

$$\begin{matrix}NDg ( m , n ) = N D q ( m , n ) - ΔV c ( m , n ) \\ = V dd - \{ V ini - V data ( m , n ) - V th \} \\ = V dd - V ini + V data ( m , n ) + V th .\end{matrix} \qquad ( equation 4 )$$

According to the illustrations above, the voltage difference Vgs between the gate terminal G and the source terminal S of the light-intensity control transistor Tled(m, n) is equivalent to the voltage difference between the voltage of the internal-node NDg(m, n) and the voltage of the internal-node NDs(m, n). That is, Vgs=NDg(m, n)-NDs(m, n). According to equation 4, the voltage difference Vgs between the gate terminal G and the source terminal S of the light-intensity control transistor Tled(m, n) can be represented by equation 5.

$$\begin{matrix}V gs = NDg ( m , n ) - NDs ( m , n ) \\ = \{ V dd - V ini + V data ( m , n ) + V th \\ = - V ini + V data ( m , n ) + V th .\end{matrix} \qquad ( equation 5 )$$

According to the voltage difference Vgs between the gate terminal G and the source terminal S of the light-intensity control transistor Tled(m, n) in equation 5 (Vgs=−Vini+Vdata(m, n)+Vth), the current value of the pixel current I_{LED}(m, n) flowing through the μLED(m, n) can be represented according to the transistor current formula, as shown in equation 6.

$$\begin{matrix}{I}_{L E D} ( m , n ) = {K ( V gs - V th )}^{2} \\ = {K [ ( - V ini + V data ( m , n ) + V th ) - V th ]}^{2} \\ = K {\{ - V ini + V data ( m , n ) \}}^{2}\end{matrix} \qquad ( equation 6 )$$

As shown in equation 6, the current value of the pixel current I_{LED}(m, n) flowing through the μLED(m, n) is only related to the preset voltage Vini and the pixel-data setting voltage Vdata(m, n), and the current value of the pixel current I_{LED}(m, n) is irrelevant to the threshold voltage Vth. Compared with the conventional pixel circuit PXLo(m, n), fewer parameters need to be considered when the timing control circuit controls the light-intensity of the pixel circuit PXLd1(m, n) according to the embodiment of the present disclosure.

Please refer to FIGS. 12 and 13A-13C for illustrations about how the voltages of the internal-nodes NDq(m, n), NDg(m, n), and NDs(m, n) in the pixel circuit PXLd1(m, n) change with the voltages of the reset gate-line signal RS[n], the pixel-data setting gate-line signal WS[n], the data-line signal DAT[m], and the light-emission activate gate-line signal EM[n]during the light-intensity reset duration Trs, the pixel-data voltage-setting duration Tdat_wrt, and the pixel light-emission duration Tea.

The voltages of the signals shown in FIG. 11 during the light-intensity reset duration Trs, the pixel-data voltage-setting duration Tdat_wrt and the pixel light-emission duration Ter are summarized in Table 6. Please refer to Table 6 and FIGS. 11, 12, and 13A-13C together.

TABLE 6

| pixel circuit PXLd1(m, n) | | duration | | |
|---|---|---|---|---|
| signal | | light- | pixel-data | pixel- |
| | | intensity | voltage- | emission |
| | | reset | setting | duration |
| | | duration | duration | Tem |
| | | Trs | Tdat_wrt | |
| signals | reset gate-line | VGL | VGH | |
| received | signal | | | |
| from the | RS[n] | | | |
| timing | pixel-data | VGH | VGL | VGH |
| control | setting gate-line | | | |
| circuit | WS[n] | | | |
| | data-line signal | Vss | Vdata(m, n) | Vss |
| | DAT[m] | | | |
| | light-emission | VGH | | VGL |
| | activate gate- | | | |
| | line signal | | | |
| | EM[n] | | | |
| internal- | NDq(m, n) | Vini | | Vdd |
| node | NDg(m, n) | Vss | Vdata(m, n)- | Vdd-Vini + |
| | | | Vth | Vdata(m, |
| | | | | n)-Vth |
| | NDs(m, n) | Vdd | Vdata(m, n) | Vdd |

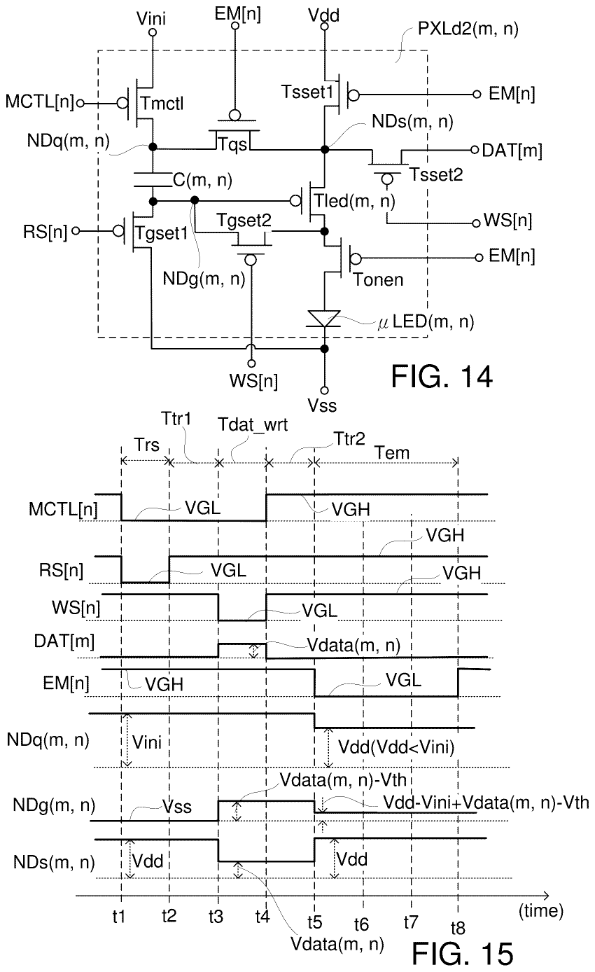

FIG. 14 is a schematic diagram illustrating the embodiment of the pixel circuit PXLd2(m, n) according to the concept of the present disclosure. As the internal components of the pixel circuit PXLd2(m, n) in FIG. 14 are similar to those of the pixel circuit PXLd1(m, n) in FIG. 11, detailed illustrations are omitted. Compared with FIG. 11, the internal-node setting transistors Tqset1 and Tqset2 in FIG. 11 are replaced by a control-combined transistor Tmctl in FIG. 14. The source terminal S of the control-combined transistor Tmctl is electrically connected to the preset voltage line Vini, the gate terminal G of the control-combined transistor Tmctl is electrically connected to the control-combined gate-line MCTL[n], and the drain terminal D of the control-combined transistor Tmctl is electrically connected to the internal-node NDq(m, n). The voltage of the control-combined gate-line signal MCTL[n] is between the low gate-control voltage VGL and the high gate-control voltage VGH.

FIG. 15 is a waveform diagram corresponding to the pixel circuit PXLd2(m, n) in FIG. 14. In FIG. 15, the horizontal axis represents time. From top to bottom, the vertical axis represents the voltages of the signals received from the timing control circuit, including the control-combined gate-line signal MCTL[n], the reset gate-line signal RS[n], the pixel-data setting gate-line signal WS[n], and the data-line signal DAT[m], and the light-emission activate gate-line signal EM[n], and the voltages of the internal-nodes NDq(m, n), NDg(m, n), and NDs(m, n) in the pixel circuit PXLd2(m, n). Compared with the embodiment in FIG. 11, the timing control circuit needs to transmit an extra signal (that is, the control-combined gate-line signal MCTL[n]) to control the pixel circuit PXLd2(m, n) in FIG. 14, but a transistor can be removed.

The voltage of the control-combined gate-line signal MCTL[n]remains at the high gate-control voltage VGH (MCTL[n]=VGH) before the time point t1. The voltage of the control-combined gate-line signal MCTL[n]remains at the low gate-control voltage VGL (MCTL[n]=VGL) between the time point t1 and the time point t4. Besides, the voltage of the control-combined gate-line signal MCTL[n]changes again from the low gate-control voltage VGL to the high gate-control voltage VGH (MCTL[n]=VGL->VGH) at the time point t4. The duration (between the time point t1 and the time point t4) when the voltage of the control-combined gate-line signal MCL[n] is equivalent to the low gate-control voltage VGL (MCTL[n]=VGL) covers the duration (between the time point t1 and the time point t2) when the voltage of the reset gate-line signal RS[n] is equivalent to the low gate-control voltage VGL (RS[n]=VGL), the duration (between the time point t3 and the time point t4) when the voltage of the pixel-data setting gate-line signal WS[n] is equivalent to the low gate-control voltage VGL (WS[n]=VGL), and the transition duration Ttr1 (between the time point t2 and the time point t3) in between.

Alternatively speaking, the duration when the voltage of the control-combined gate-line signal MCL[n] is equivalent to the low gate-control voltage VGL (MCTL[n]=VGL) covers the light-intensity reset duration Trs, the transition Ttr1, and the pixel-data voltage-setting duration Tdat_wrt. With such design, the voltage-setting relationship in FIG. 14 that the voltage of the internal-node NDq(m, n) is set in response to the control-combined transistor Tmctl being switched on in response to the low gate-control voltage VGL (MCTL[n]=VGL) at the control-combined gate-line signal MCTL[n]during the light-intensity reset duration Trs is similar to the voltage-setting relationship in FIG. 11 that the voltage of the internal-node NDq(m, n) is set in response to the internal-node setting transistor Tqset2 being switched on in response to the low gate-control voltage VGL at the reset gate-line RS[n](RS[n]=VGL) during the light-intensity reset duration Trs. Moreover, the voltage-setting relationship in FIG. 14 that the voltage of the internal-node NDq(m, n) is set in response to the control-combined transistor Tmctl being switched on in response to the low gate-control voltage VGL at the control-combined gate-line MCTL[n](MCTL[n]=VGL) during the pixel-data voltage-setting duration Tdat_wrt is similar to the voltage-setting relationship in FIG. 11 that the voltage of the internal-node NDq(m, n) is set in response to the internal-node setting transistor Tqset1 being switched on in response to the low gate-control voltage VGL at the pixel-data setting gate-line WS[n](WS[n]=VGL) during the pixel-data voltage-setting duration Tdat_wrt. Therefore, the control-combined transistor Tmctl in FIG. 14 is placed additionally to replace the two internal-node setting transistors Tqset1 and Tqset2 in FIG. 11.

Please refer to FIGS. 14 and 15 together. Detailed illustrations of FIG. 15 are omitted as the waveforms and timing sequences of the signals that the timing control circuit transmits to the pixel circuit PXLd2(m, n), including the reset gate-line signal RS[n], the pixel-data setting gate-line signal WS[n], the data-line signal DAT[m], the light-emission activate gate-line signal EM[n], and the internal-nodes NDq(m, n), NDg(m, n), and NDs(m, n), in FIG. 15 are similar to those in FIG. 12.

Based on the above illustrations, the PAM-based embodiments of the pixel circuits PXLa(m, n), PXLb1(m, n), PXLb2(m, n), PXLb3(m, n), PXLc(m, n) in FIGS. 3-10, according to the concept of the present disclosure, can exclude the parameters related to the threshold voltage Vth of the light-intensity control transistor Tled(m, n) and the preset voltage Vini when the timing control circuit controls the pixel current I_{LED}(m, n) of the pixel circuit. Thus, the circuit design can be simplified. On the other hand, FIGS. 11-15 of the present disclosure collectively provide some other PAM-based embodiments of the pixel circuits PXLd1(m, n) and PXLd2(m, n) according to the concept of the present disclosure. Similarly, these embodiments can simplify the control complexity between the timing control circuit and the pixel circuits PXLd1(m, n) and PXLd2(m, n).

The aperture ratio of the display panel represents the ratio of the light-transmitting area in the non-pixel wiring region to the pixel region of the display panel. The higher aperture ratio implies that the light transmission efficiency of the display panel is higher and the transparency effect of the display panel is better.

In the embodiments illustrated above, most of the pixel circuits PXL(m, n) need only three voltage sources with fixed voltage values (that is, the supply voltage Vdd, the ground voltage Vss, and the preset voltage Vini). In the first type of embodiment, the preset voltage Vini can be further replaced with the supply voltage Vdd. The aperture ratio of the display panel becomes higher because fewer voltage sources having fixed voltage values are required. Moreover, some embodiments adopt the control-combined transistor Tmctl to reduce the number of transistors in the pixel circuit so that the aperture ratio can be further improved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A pixel circuit, comprising:
a light-emitting diode, having a terminal being electrically connected to a supply voltage line;
a first-first internal-node setting transistor, electrically connected to other terminal of the light-emitting diode and a first internal-node;
a first-second internal-node setting transistor, electrically connected to a second internal-node and a data-line, wherein a voltage of the data-line during a pixel-data voltage-setting duration is equivalent to a pixel-data setting voltage; and
a light-intensity control transistor, electrically connected to the first internal-node, the second internal-node, and a ground voltage line, wherein a voltage of the supply voltage line is greater than a voltage of the ground voltage line, wherein
a pixel current flows from the supply voltage line to the ground voltage line, through the light-emitting diode, the first-first internal-node setting transistor, the first internal-node, and the light-intensity control transistor during a pixel light-emission duration after the pixel-data voltage-setting duration ends, wherein
a current value of the pixel current is related to a voltage of the first internal-node and a voltage of the second internal-node during the pixel light-emission duration, and
the voltage of the second internal-node during the pixel light-emission duration is related to a threshold voltage of the light-intensity control transistor and the pixel-data setting voltage.

2. The pixel circuit according to claim 1, wherein
the first-first internal-node setting transistor is electrically connected to a light-emission activate gate-line, wherein the first-first internal-node setting transistor is switched on in response to a voltage of the light-emission activate gate-line during the pixel light-emission duration, and
the first-second internal-node setting transistor is electrically connected to a pixel-data setting gate-line, wherein the first-second internal-node setting transistor is switched on in response to a voltage of the pixel-data setting gate-line during the pixel-data voltage-setting duration.

3. The pixel circuit according to claim 2, further comprising:
a second-first internal-node setting transistor, electrically connected to a reset gate-line, wherein the second-first internal-node setting transistor is switched on in response to a voltage of the reset gate-line during a light-intensity reset duration before the pixel-data voltage-setting duration starts,
a second-second internal-node setting transistor, electrically connected to the second internal-node and the reset gate-line, wherein the second-second internal-node setting transistor is switched on in response to the voltage of the reset gate-line during the light-intensity reset duration; and
a third-second internal-node setting transistor, electrically connected to the second internal-node, a third internal-node, and the light-emission activate gate-line, wherein the third-second internal-node setting transistor is switched on in response to the voltage of the light-emission activate gate-line during the pixel light-emission duration.

4. The pixel circuit according to claim 3, wherein
the second-first internal-node setting transistor and the second-second internal-node setting transistor are electrically connected to one of the supply voltage line and a preset voltage line.

5. The pixel circuit according to claim 4, wherein the voltage of the supply voltage line is equivalent to a voltage of the preset voltage line.

6. The pixel circuit according to claim 3, further comprising:
a capacitor, electrically connected to the first internal-node and the third internal-node;
a first-third internal-node setting transistor, electrically connected to the pixel-data setting gate-line, wherein the first-third internal-node setting transistor is switched on in response to the voltage of the pixel-data setting gate-line during the pixel-data voltage-setting duration; and
a second-third internal-node setting transistor, electrically connected to the reset gate-line and the third internal-node, wherein the second-third internal-node setting transistor is switched on in response to the voltage of the reset gate-line during the light-intensity reset duration.

7. The pixel circuit according to claim 6, wherein
the first-third internal-node setting transistor is electrically connected to one of the ground voltage line, the supply voltage line, and a preset voltage line, and
the second-third internal-node setting transistor is electrically connected to one of the ground voltage line, the supply voltage line, and the preset voltage line.

8. The pixel circuit according to claim 3, further comprising:
a capacitor, electrically connected to the first internal-node and a third internal-node; and
a control-combined transistor, electrically connected to the third internal-node and a control-combined gate-line, wherein the control-combined transistor is switched on in response to a voltage of the control-combined gate-line during the light-intensity reset duration and the pixel-data voltage-setting duration.

9. The pixel circuit according to claim 8, wherein
the control-combined transistor is electrically connected to one of the ground voltage line, the supply voltage line, and a preset voltage line.

10. The pixel circuit according to claim 3, wherein
the voltage of the reset gate-line is equivalent to a low gate-control voltage during the light-intensity reset duration, and the voltage of the reset gate-line is equivalent to a high gate-control voltage during the pixel-data voltage-setting duration and the pixel light-emission duration;
the voltage of the pixel-data setting gate-line is equivalent to the low gate-control voltage during the pixel-data voltage-setting duration, and the voltage of the pixel-data setting gate-line is equivalent to the high gate-control voltage during the light-intensity reset duration and the pixel light-emission duration; and
the voltage of the light-emission activate gate-line is equivalent to the low gate-control voltage during the pixel light-emission duration, and the voltage of the light-emission activate gate-line is equivalent to the high gate-control voltage during the light-intensity reset duration and the pixel-data voltage-setting duration.

11. The pixel circuit according to claim 1, wherein
the pixel-data setting voltage corresponds to a grayscale of the pixel circuit, and
a timing control circuit sets the voltage of the data-line to be equivalent to the pixel-data setting voltage before the pixel-data voltage-setting duration starts.

12. The pixel circuit according to claim 1, wherein
the light-emitting diode emits light during the pixel light-emission duration, and
light-intensity of the light is determined by the pixel current.

13. A pixel circuit, comprising:
a light-emitting diode, having a terminal being electrically connected to a ground voltage line;
a light-emission activate transistor, electrically connected to other terminal of the light-emitting diode;
a light-intensity control transistor, electrically connected to the light-emission activate transistor, a first internal-node, and a second internal-node;
a first-first internal-node setting transistor, electrically connected to the first internal-node and a supply voltage line, wherein a voltage of the supply voltage line is greater than a voltage of the ground voltage line; and
a second-first internal-node setting transistor, electrically connected to the first internal-node and a data-line, wherein a voltage of the data-line during a pixel-data voltage-setting duration is equivalent to a pixel-data setting voltage, wherein
a pixel current flows from the supply voltage line to the ground voltage line, through the first-first internal-node setting transistor, the first internal-node, the light-intensity control transistor, and the light-emitting diode, during a pixel light-emission duration after the pixel-data voltage-setting duration ends, wherein
a current value of the pixel current is related to a voltage of the first internal-node and a voltage of the second internal-node during the pixel light-emission duration, and
the voltage of the second internal-node during the pixel light-emission duration is related to a threshold voltage of the light-intensity control transistor and the pixel-data setting voltage.

14. The pixel circuit according to claim 13, wherein
the first-first internal-node setting transistor is electrically connected to a light-emission activate gate-line, wherein the first-first internal-node setting transistor is switched on in response to a voltage of the light-emission activate gate-line during the pixel light-emission duration, and
the second-first internal-node setting transistor is electrically connected to a pixel-data setting gate-line, wherein the second-first internal-node setting transistor is switched on in response to a voltage of the pixel-data setting gate-line during the pixel-data voltage-setting duration.

15. The pixel circuit according to claim 14, further comprising:
a first-second internal-node setting transistor, electrically connected to the second internal-node, the ground voltage line, and a reset gate-line, wherein the first-second internal-node setting transistor is switched on in response to a voltage of the reset gate-line during a light-intensity reset duration before the pixel-data voltage-setting duration starts; and
a second-second internal-node setting transistor, electrically connected to the second internal-node, the light-emission activate transistor, and the pixel-data setting gate-line, wherein the second-second internal-node setting transistor is switched on in response to the voltage of the pixel-data setting gate-line during the pixel-data voltage-setting duration.

16. The pixel circuit according to claim 15, further comprising:
an internal-node bridging transistor, electrically connected to the first internal-node, the light-emission activate gate-line, and the third internal-node, wherein the internal-node bridging transistor is switched on in response to the voltage of the light-emission activate gate-line during the pixel light-emission duration; and
a capacitor, electrically connected to the second internal-node and the third internal-node.

17. The pixel circuit according to claim 16, further comprising:
a first-third internal-node setting transistor, electrically connected to the pixel-data setting gate-line and the third internal-node, wherein the first-third internal-node setting transistor is switched on in response to the voltage of the pixel-data setting gate-line during the pixel-data voltage-setting duration; and
a second-third internal-node setting transistor, electrically connected to the reset gate-line and the third internal-node, wherein the second-third internal-node setting transistor is switched on in response to the voltage of the reset gate-line during the light-intensity reset duration.

18. The pixel circuit according to claim 17, wherein
the voltage of the reset gate-line is equivalent to a low gate-control voltage during the light-intensity reset duration, and the voltage of the reset gate-line is equivalent to a high gate-control voltage during the pixel-data voltage-setting duration and the pixel light-emission duration;
the voltage of the pixel-data setting gate-line is equivalent to the low gate-control voltage during the pixel-data voltage-setting duration, and the voltage of the pixel-data setting gate-line is equivalent to the high gate-control voltage during the light-intensity reset duration and the pixel light-emission duration; and
the voltage of the light-emission activate gate-line is equivalent to the low gate-control voltage during the pixel light-emission duration, and the voltage of the light-emission activate gate-line is equivalent to the high gate-control voltage during the light-intensity reset duration and the pixel-data voltage-setting duration.

19. The pixel circuit according to claim 16, further comprising:
a control-combined transistor, electrically connected to the third internal-node and a control-combined gate-line, wherein the control-combined transistor is switched on in response to a voltage of the control-combined gate-line during the light-intensity reset duration and the pixel-data voltage-setting duration.

20. The pixel circuit according to claim 19, wherein
the voltage of the control-combined gate-line is equivalent to a low gate-control voltage during the light-intensity reset duration and the pixel-data voltage-setting duration, and the voltage of the control-combined gate-line is equivalent to a high gate-control voltage during the pixel light-emission duration;
the voltage of the reset gate-line during the light-intensity reset duration is equivalent to the low gate-control voltage during the light-intensity reset duration, and the voltage of the reset gate-line is equivalent to the high gate-control voltage during the pixel-data voltage-setting duration and the pixel light-emission duration;
the voltage of the pixel-data setting gate-line is equivalent to the low gate-control voltage during the pixel-data voltage-setting duration, and the voltage of the pixel-data setting gate-line is equivalent to the high gate-control voltage during the light-intensity reset duration and the pixel light-emission duration; and
the voltage of the light-emission activate gate-line is equivalent to the low gate-control voltage during the pixel light-emission duration, and the voltage of the light-emission activate gate-line is equivalent to the high gate-control voltage during the light-intensity reset duration and the pixel-data voltage-setting duration.
